(19) United States
(12) Patent Application Publication
(10) Pub. No.: US 2013/0268265 A1
(43) Pub. Date: Oct. 10, 2013

(54) METHOD AND DEVICE FOR PROCESSING AUDIO SIGNAL

(71) Applicants: Gyuhyeok Jeong, Seocho-gu (KR); Hyejeong Jeon, Seocho-gu (KR); Lagyoung Kim, Seocho-gu (KR); Byungsuk Lee, Seocho-gu (KR); Ingyu Kang, Seocho-gu (KR)

(72) Inventors: Gyuhyeok Jeong, Seocho-gu (KR); Hyejeong Jeon, Seocho-gu (KR); Lagyoung Kim, Seocho-gu (KR); Byungsuk Lee, Seocho-gu (KR); Ingyu Kang, Seocho-gu (KR)

(21) Appl. No.: 13/807,918

(22) PCT Filed: Jul. 1, 2011
(86) PCT No.: PCT/KR2011/004843

§ 371 Date: Jun. 17, 2013

Related U.S. Application Data
(60) Provisional application No. 61/360,506, filed on Jul. 1, 2010.
(60) Provisional application No. 61/383,737, filed on Sep. 17, 2010.
(60) Provisional application No. 61/490,080, filed on May 26, 2011.

(51) Int. Cl. G10L 19/06

(52) U.S. Cl. CPC G10L 19/06
USPC 704/210; 704/205

(57) ABSTRACT

The present invention relates to a method for processing an audio signal, and the method comprises the steps of: receiving an audio signal; determining a coding mode corresponding to a current frame, by receiving network information for indicating the coding mode; encoding the current frame of said audio signal according to said coding mode; and transmitting said encoded current frame, wherein said coding mode is determined by the combination of a bandwidth and bitrate, and said bandwidth includes two or more bands among narrowband, wideband, and super wideband.

### TECHNICAL FIELD

The present invention relates to an audio signal processing method and an audio signal processing device which are capable of encoding or decoding an audio signal.

### BACKGROUND

Generally, for an audio signal containing strong speech signal characteristics, linear predictive coding (LPC) is performed. Linear predictive coefficients generated by linear predictive coding are transmitted to a decoder, and the decoder reconstructs the audio signal through linear predictive synthesis using the coefficients.

### DISCLOSURE

### Technical Problem

Generally, an audio signal comprises signals of various frequencies. As examples of such signals, human audible frequency ranges from 20 Hz to 20 kHz while human speech frequency ranges from 200 Hz to 3 kHz. An input audio signal may include not only a band of human speech but also high frequency region components over 7 kHz which human voice rarely reaches. As such, if a coding scheme suitable for narrowband (about 4 kHz or below) is used for wideband (about kHz or below) or super wideband (about 16 kHz or below), speech quality may be deteriorated.

### Technical Solution

An object of the present invention can be achieved by providing an audio signal processing method and device for applying coding modes in a such manner that the coding modes are switched for respective frames according to network conditions (and audio signal characteristics).

Another object of the present invention, in order to apply appropriate coding schemes to respective bandwidths, is to provide an audio signal processing method and an audio signal processing device for switching coding schemes according to bandwidths for respective frames by switching coding modes for respective frames.

Another object of the present invention is to provide an audio signal processing method and an audio signal processing device for, in addition to switching coding schemes according to bandwidths for respective frames, applying various bitrates for respective frames.

Another object of the present invention is to provide an audio signal processing method and an audio signal processing device for generating respective- type silence frames and transmitting the same based on bandwidths when a current frame corresponds to a speech inactivity section.

Another object of the present invention is to provide an audio signal processing method and an audio signal processing device for generating a unified silence frame and transmitting the same irrelevant to bandwidths when a current frame corresponds to a speech inactivity section.

Another object of the present invention is to provide an audio signal processing method and an audio signal processing device for smoothing a current frame with the same bandwidth as a previous frame, if the bandwidth of the current frame is different from that of the previous frame.

### Advantageous Effects

The present invention provides the following effects and advantages.

Firstly, by switching coding modes for respective frames according to feedback information from a network, coding schemes may be adaptively switched according to conditions of the network (and a receiver's terminal), so that encoding suitable for a communication environment may be performed and transmission may be performed at relatively low bit rates to a transmitting side.

Secondly, by switching coding modes for respective frames taking account of audio signal characteristics in addition to network information, bandwidths or bit rates may be adaptively changed to the extent that network conditions allow.

Thirdly, in a speech activity section, switching is performed by selecting other bandwidths at or below allowable bitrates based on network information, an audio signal of good quality may be provided to a receiving side.

Fourthly, when bandwidths having the same or different bitrates are switched in a speech activity section, discontinuity due to bandwidth change may be prevented by performing smoothing based on bandwidths of previous frames at a transmitting side.

Fifthly, in a speech inactivity section, a type of a silence frame for a current frame is determined depending on bandwidth(s) of previous frame(s), thus distortions due to bandwidth switching may be prevented

Sixthly, in a speech inactivity section, by applying a unified silence frame irrelevant to previous or current frames, power for control, resources, and the number of modes at the time of transmission may be reduced, distortions due to bandwidth switching may be prevented.

Seventhly, if a bandwidth is changed in a transition from a speech activity section to a speech inactivity section, by performing smoothing on a bandwidth of a current frame based on previous frames at a receiving end, discontinuity due to bandwidth change may be prevented.

### DESCRIPTION OF DRAWINGS

FIG. 1 is a block diagram illustrating a configuration of an encoder of an audio signal processing device according to an embodiment of the present invention;

FIG. 2 is a diagram illustrating an example including narrowband (NB) coding scheme, wideband (WB) coding scheme and super wideband (SWB) coding scheme;

FIG. 3 is a diagram illustrating a first example of a mode determination unit 110 in FIG. 1;

FIG. 4 is a diagram illustrating a second example of the mode determination unit 110 in FIG. 1;

FIG. 5 is a diagram illustrating an example of a plurality of coding modes;

FIG. 6 is a graph illustrating an example of coding modes switched for respective frames;

FIG. 7 is a graph in which the vertical axis of the graph in FIG. 6 is represented with bandwidth;

FIG. 8 is a graph in which the vertical axis of the graph in FIG. 6 is represented with bitrates;

FIG. 9 is a diagram conceptually illustrating a core layer and an enhancement layer;

FIG. 10 is a graph in a case that bits of an enhancement layer are variable;

FIG. 11 is a graph of a case in which bits of a core layer are variable;

FIG. 12 is a graph of a case in which bits of the core layer and the enhancement layer are variable;

FIG. 13 is a diagram illustrating a first example of a silence frame generating unit 140;

FIG. 14 is a diagram illustrating a procedure in which a silence frame appears;

FIG. 15 is a diagram illustrating examples of syntax of respective-types-of silence frames;

FIG. 16 is a diagram illustrating a second example of the silence frame generating unit 140;

FIG. 17 is a diagram illustrating an example of syntax of a unified silence frame;

FIG. 18 is a diagram illustrating a third example of the silence frame generating unit 140;

FIG. 19 is a diagram illustrating the silence frame generating unit 140 of the third example;

FIG. 20 is a block diagram schematically illustrating decoders according to the embodiment of the present invention;

FIG. 21 is a flowchart illustrating a decoding procedure according to the embodiment of the present invention;

FIG. 22 is a block diagram schematically illustrating configurations of encoders and decoders according to an alternative embodiment of the present invention;

FIG. 23 is a diagram illustrating a decoding procedure according to the alternative embodiment;

FIG. 24 is a block diagram illustrating a converting unit of a decoding device of the present invention;

FIG. 25 is a block diagram schematically illustrating a configuration of a product in which an audio signal processing device according to an exemplary embodiment of the present invention is implemented;

FIG. 26 is a diagram illustrating relation between products in which the audio signal processing device according to the exemplary embodiment is implemented; and

FIG. 27 is a block diagram schematically illustrating a configuration of a mobile terminal in which the audio signal processing device according to the exemplary embodiment is implemented.

### BEST MODE

In order to achieve such objectives, an audio signal processing method according to the present invention includes receiving an audio signal, receiving network information indicative of a coding mode and determining the coding mode corresponding to a current frame, encoding the current frame of the audio signal according to the coding mode, and transmitting the encoded current frame. The coding mode is determined based on a combination of bandwidths and bitrates, and the bandwidths comprise at least two of narrowband, wideband, and super wideband.

According to the present invention, the bitrates may include two or more predetermined support bitrates for each of the bandwidths.

According to the present invention, the super wideband is a band that covers the wideband and the narrowband, and the wideband is a band that covers the narrowband.

According to the present invention, the method may further include determining whether or not the current frame is a speech activity section by analyzing the audio signal, in which the determining and the encoding may be performed if the current frame is the speech activity section.

According to another aspect of the present invention, provided herein is an audio signal processing method comprising receiving an audio signal, receiving network information indicative of a maximum allowable coding mode, determining a coding mode corresponding to a current frame based on the network information and the audio signal, encoding the current frame of the audio signal according to the coding mode, and transmitting the encoded current frame. The coding mode is determined based on a combination of bandwidths and bitrates, and the bandwidths comprise at least two of narrowband, wideband, and super wideband.

According to the present invention, the determining a coding mode may include determining one or more candidate coding modes based on the network information, and determining one of the candidate coding modes as the coding mode based on characteristics of the audio signal.

According to another aspect of the present invention, provided herein is an audio signal processing device comprising a mode determination unit for receiving network information indicative of a coding mode and determining the coding mode corresponding to a current frame, and an audio encoding unit for receiving an audio signal, for encoding the current frame of the audio signal according to the coding mode, and for transmitting the encoded current frame. The coding mode is determined based on a combination of bandwidths and bitrates, and the bandwidths comprise at least two of narrowband, wideband, and super wideband.

According to another aspect of the present invention, provided herein is an audio signal processing device comprising a mode determination unit for receiving an audio signal, for receiving network information indicative of a maximum allowable coding mode, and for determining a coding mode corresponding to a current frame based on the network information and the audio signal, and an audio encoding unit for encoding the current frame of the audio signal according to the coding mode, and for transmitting the encoded current frame,. The coding mode is determined based on a combination of bandwidths and bitrates, and the bandwidths comprise at least two of narrowband, wideband, and super wideband.

According to another aspect of the present invention, provided herein is an audio signal processing method comprising receiving an audio signal, determining whether a current frame is a speech activity section or a speech inactivity section by analyzing the audio signal, if the current frame is the speech inactivity section, determining one of a plurality of types including a first type and a second type as a type of a silence frame for the current frame based on bandwidths of one or more previous frames, and for the current frame, generating and transmitting the silence frame of the determined type. The first type includes a linear predictive conversion coefficient of a first order, the second type includes a linear predictive conversion coefficient of a second order, and the first order is smaller than the second order.

According to the present invention, the plurality of types may further include a third type, the third type includes a linear predictive conversion coefficient of a third order, and the third order is greater than the second order.

According to the present invention, the linear predictive conversion coefficient of the first order may be encoded with first bits, the linear predictive conversion coefficient of the second order may be encoded with second bits, and the first bits may be smaller than the second bits.

According to the present invention, the total bits of each of the first, second, and third types may be the same.

According to another aspect of the present invention, provided herein is an audio signal processing device comprising an activity section determination unit for receiving an audio signal, and determining whether a current frame is a speech activity section or a speech inactivity section by analyzing the audio signal, a type determination unit, if the current frame is not the speech inactivity section, for determining one of a plurality of types including a first type and a second type as a type of a silence frame for the current frame based on bandwidths of one or more previous frames, and a respective-types-of silence frame generating unit, for the current frame, for generating and transmitting the silence frame of the determined type. The first type includes a linear predictive conversion coefficient of a first order, the second type includes a linear predictive conversion coefficient of a second order, and the first order is smaller than the second order.

According to another aspect of the present invention, provided herein is an audio signal processing method comprising receiving an audio signal, determining whether a current frame is a speech activity section or a speech inactivity section by analyzing the audio signal, if a previous frame is a speech inactivity section and the current frame is the speech activity section, and if a bandwidth of the current frame is different from a bandwidth of a silence frame of the previous frame, determining a type corresponding to the bandwidth of the current frame from among a plurality of types, and generating and transmitting a silence frame of the determined type. The plurality of types comprises first and second types, the bandwidths comprise narrowband and wideband, and the first type corresponds to the narrowband, and the second type corresponds to the wideband.

According to another aspect of the present invention, provided herein is an audio signal processing device comprising an activity section determination unit for receiving an audio signal and determining whether a current frame is a speech activity section or a speech inactivity section by analyzing the audio signal, a control unit, if a previous frame is a speech inactivity section and the current frame is the speech activity section, and if a bandwidth of the current frame is different from a bandwidth of a silence frame of the previous frame, for determining a type corresponding to the bandwidth of the current frame from among a plurality of types, and a respective-types-of silence frame generating unit for generating and transmitting a silence frame of the determined type. The plurality of types comprises first and second types, the bandwidths comprise narrowband and wideband, and the first type corresponds to the narrowband, and the second type corresponds to the wideband.

According to another aspect of the present invention, provided herein is an audio signal processing method comprising receiving an audio signal, determining whether a current frame is a speech activity section or a speech inactivity section, and if the current frame is the speech inactivity section, generating and transmitting a unified silence frame for the current frame, regardless of bandwidths of previous frames. The unified silence frame comprises a linear predictive conversion coefficient and an average of frame energy.

According to the present invention, the linear predictive conversion coefficient may be allocated 28 bits and the average of frame energy may be allocated 7 bits.

According to another aspect of the present invention, provided herein is an audio signal processing device comprising an activity section determination unit for receiving an audio signal and for determining whether a current frame is a speech activity section or a speech inactivity section by analyzing the audio signal, and a unified silence frame generating unit, if the current frame is the speech inactivity section, for generating and transmitting a unified silence frame for the current frame, regardless of bandwidths of previous frames. The unified silence frame comprises a linear predictive conversion coefficient and an average of frame energy.

### MODE FOR INVENTION

Reference will now be made in detail to the preferred embodiments of the present invention, examples of which are illustrated in the accompanying drawings. It should be understood that the terms used in the specification and appended claims should not be construed as limited to general and dictionary meanings but be construed based on the meanings and concepts according to the spirit of the present invention on the basis of the principle that the inventor is permitted to define appropriate terms for best explanation. The preferred embodiments described in the specification and shown in the drawings are illustrative only and are not intended to represent all aspects of the invention, such that various equivalents and modifications can be made without departing from the spirit of the invention.

As used herein, the following terms may be construed as follows; and, other terms may be construed in a similar manner. Coding may be construed as encoding or decoding depending on context, and information may be construed as a term covering values, parameter, coefficients, elements, etc. depending on context. However, the present invention is not limited thereto.

Here, an audio signal, in contrast to a video signal in a broad sense, refers to a signal which may be recognized by auditory sense when reproduced and, in contrast to a speech signal in a narrow sense, refers to a signal having no or few speech characteristics. Herein, an audio signal is to be construed in a broad sense and is understood as an audio signal in a narrow sense when distinguished from a speech signal.

In addition, coding may refer to encoding only or may refer to both encoding and decoding.

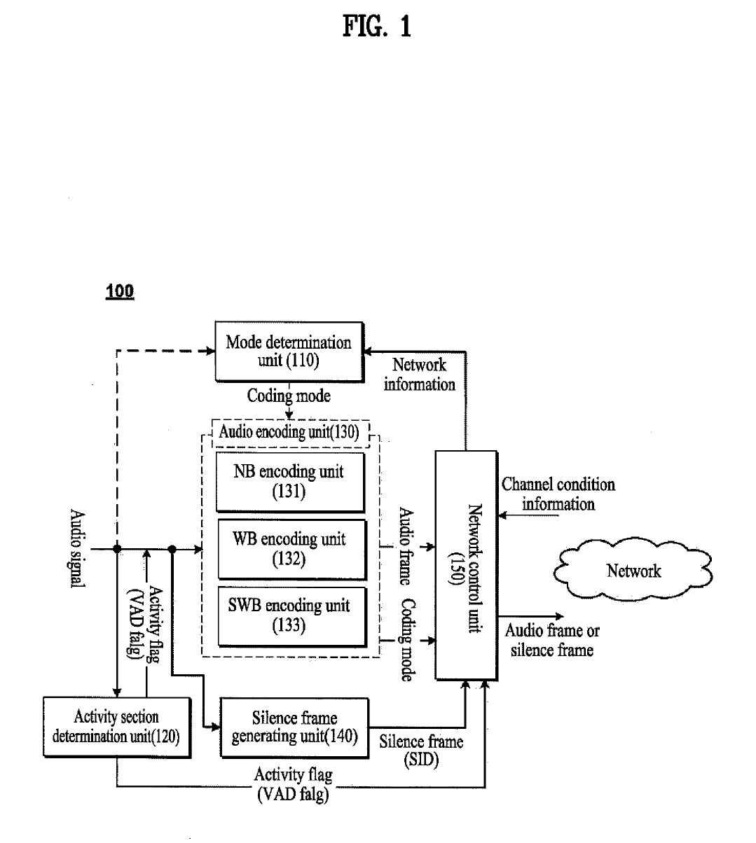

FIG. 1 illustrates a configuration of an encoder of an audio signal processing device according to an embodiment of the present invention. Referring to FIG. 1, the encoder 100 includes an audio encoding unit 130, and may further include at least one of a mode determination unit 110, an activity section determination unit 120, a silence frame generating unit 140 and a network control unit 150.

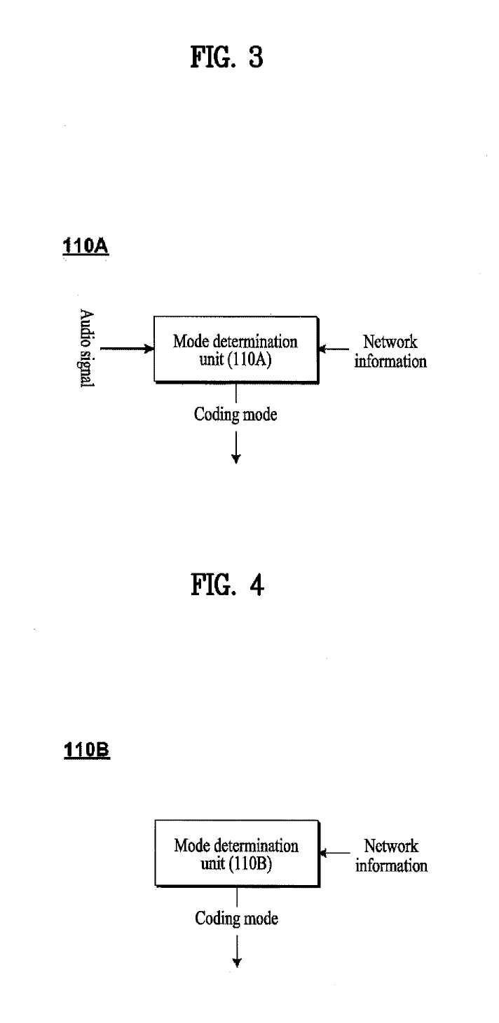

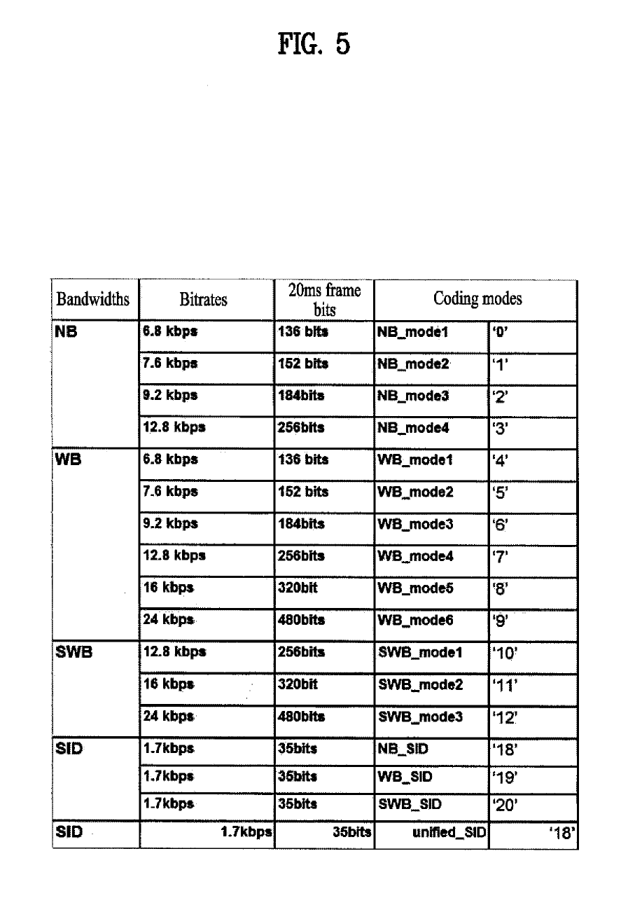

The mode determination unit 110 receives network information from the network control unit 150, determines a coding mode based on the received information, and transmits the determined coding mode to the audio encoding unit 130 (and the silence frame generating unit 140). Here, the network information may indicate a coding mode or a maximum allowable coding mode, description of each of which will be given below with reference to FIGS. 3 and 4, respectively. Further, a coding mode, which is a mode for encoding an input audio signal, may be determined from a combination of bandwidths and bitrates (and whether a frame is a silence frame), description of which will be given below with reference to FIG. 5 and the like.

On the other hand, the activity section determination unit 120 determines whether a current frame is a speech-activity section or a speech inactivity section by performing analysis of an input audio signal and transmits an activity flag (hereinafter referred to as a “VAD flag”) to the audio encoding unit 130, silence frame generating unit 140 and network control unit 150 and the like. Here, the analysis corresponds to a voice activity detection (VAD) procedure. The activity flag indicates whether the current frame is a speech-activity section or a speech inactivity section.

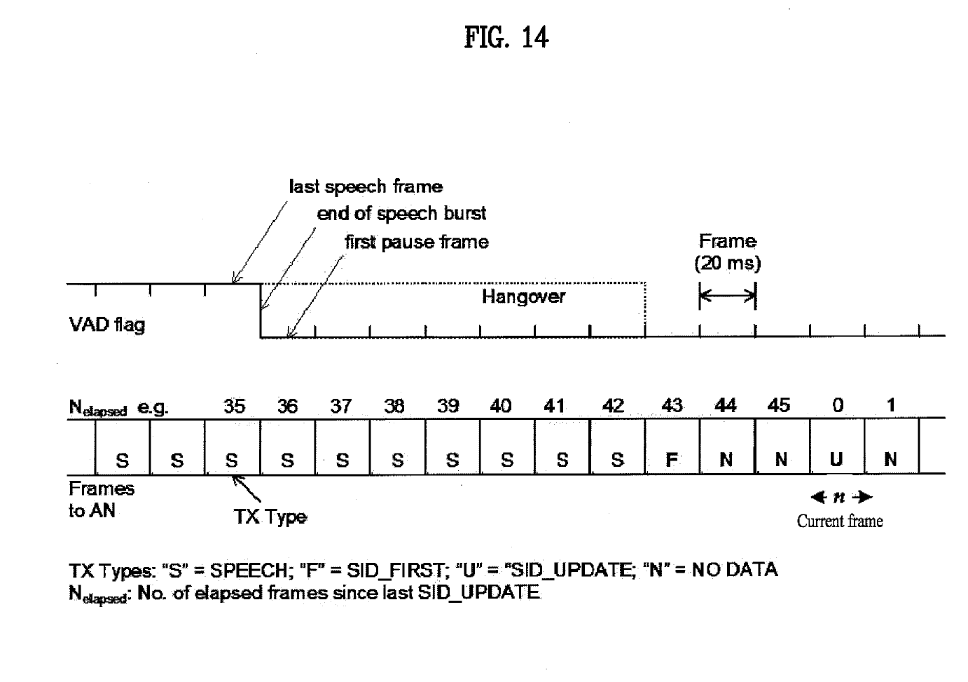

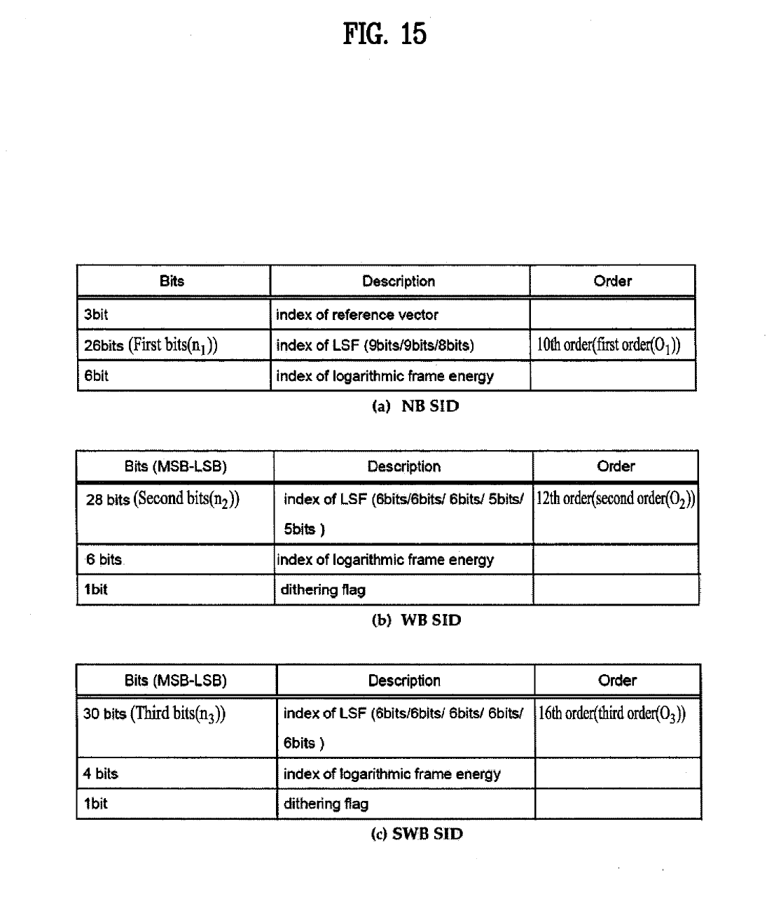

The speech inactivity section corresponds to a silence section or a section with background noise, for example. It is inefficient to use a coding scheme of the activity section in the inactivity section. Therefore, the activity section determination unit 120 transmits an activity flag to the audio encoding unit 130 and the silence frame generating unit 140 so that, in a speech activity section (VAD flag=1), an audio signal is encoded by the audio encoding unit 130 according to respective coding schemes and in a speech inactivity section (VAD flag=0) a silence frame with low bits is generated by the silence frame generating unit 140. However, exceptionally, even in the case of VAD flag=0, an audio signal may be encoded by the audio encoding unit 130, description of which will be given below with reference to FIG. 14.

The audio encoding unit 130 causes at least one of narrowband encoding unit (NB encoding unit) 131, wideband encoding unit (WB encoding unit) 132 and super wideband unit (SWB encoding unit) 133 to encode an input audio signal to generate an audio frame, based on the coding mode determined by the mode determination unit 110.

In this regard, the narrowband, the wideband, and the super wideband have wider and higher frequency bands in the named order. The super wideband (SWB) covers the wideband (WB) and the narrowband (NB), and the wideband (WB) covers the narrowband (NB).

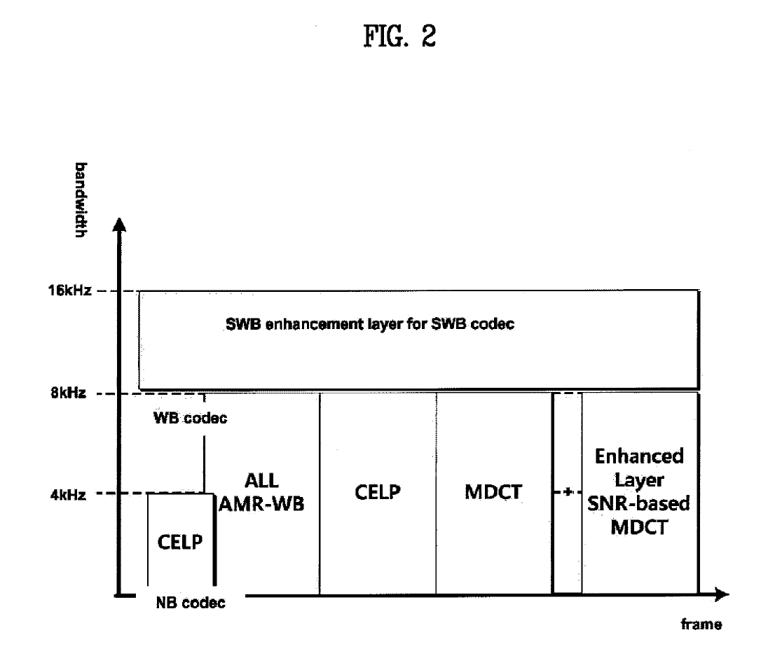

NB encoding unit 131 is a device for encoding an input audio signal according to a coding scheme corresponding to narrowband signal (hereinafter referred to as NB coding scheme), WB encoding unit 132 is a device for encoding an input audio signal according to a coding scheme corresponding to wideband signal (hereinafter referred to as WB coding scheme), and SWB encoding unit 133 is a device for encoding an input audio signal according to a coding scheme corresponding to super wideband signal (hereinafter referred to as SWB coding scheme). Although the case that different coding schemes are used for respective bands (that is, respective encoding units) has been described above, a coding scheme of an embedded structure covering lower bands may be used; or a hybrid structure of the above two structures may also be used. FIG. 2 illustrates an example of a codec with a hybrid structure.

Referring to FIG. 2, NB/WB/SWB coding schemes are speech codecs each having multi bitrates. The SWB coding scheme applies the WB coding scheme to a lower band signal unchanged. The NB coding scheme corresponds to a code excitation linear prediction (CELP) scheme, while the WB coding scheme may correspond to a scheme in which one of an adaptive multi-rate-wideband (AMR-WB) scheme, the CELP scheme and a modified discrete cosine transform (MDCT) scheme serves as a core layer and an enhancement layer is added so as to be combined as a coding error embedded structure. The SWB coding scheme may correspond to a scheme in which a WB coding scheme is applied to a signal of up to 8 kHz bandwidth and spectrum envelope information and residual signal energy is encoded for a signal of from 8 kHz to 16 kHz. The coding scheme illustrated in FIG. 2 is merely an example and the present invention is not limited thereto.

Referring back to FIG. 1, the silence frame generating unit 140 receives an activity flag (VAD flag) and an audio signal, and generates a silence frame (SID frame) for a current frame of the audio signal based on the activity flag, normally when the current frame corresponds to a speech inactivity section. Various examples of the silence frame generating unit 140 will be described below.

The network control unit 150 receives channel condition information from a network such as a mobile communication network (including a base station transceiver (BTS), a base station (BSC), a mobile switching center (MSC), a PSTN, an IP network, etc). Here, network information is extracted from the channel condition information and is transferred to the mode determination unit 110. As described above, the network information may be information which directly indicates a coding mode or indicates a maximum allowable coding mode. Further, the network control unit 150 transmits an audio frame or a silence frame to a network.

Two examples of the mode determination unit 110 will be described with reference to FIGS. 3 and 4. Referring to FIG. 3, a mode determination unit 110A according to a first example receives an audio signal and network information and determines a coding mode. Here, the coding mode may be determined by a combination of bandwidths, bitrates, etc., as illustrated in FIG. 5.

Referring to FIG. 5, about 14 to 16 coding modes in total are illustrated. Bandwidth is one factor among factors for determining a coding mode, and two or more of narrowband (NB), wideband (WB) and super wideband (SWB) are presented. Further, bitrate is another factor, and two or more support bitrates are presented for each bandwidth. That is, two or more of 6.8 kbps, 7.6 kbps, 9.2 kbps and 12.8 kbps are presented for narrowband (NB), two or more of 6.8 kbps, 7.6 kbps, 9.2 kbps, 12.8 kbps, 16 kbps and 24 kbps are presented for wideband (WB), and two or more of 12.8 kbps, 16 kbps and 24 kbps are presented for super wideband (SWB). Here, the present invention is not limited to specific bitrates.

A support bitrates which corresponds to two or more bandwidths may be presented. For example, in FIG. 5, 12.8 is present in all of NB, WB and SWB, 6.8, 7.2 and 9.2 are presented in NB and WB, and 16 and 24 are presented in WB and SWB.

The last factor for determining a coding mode is to determine whether it is a silence frame, which will be specifically described below together with the silence frame generating unit.

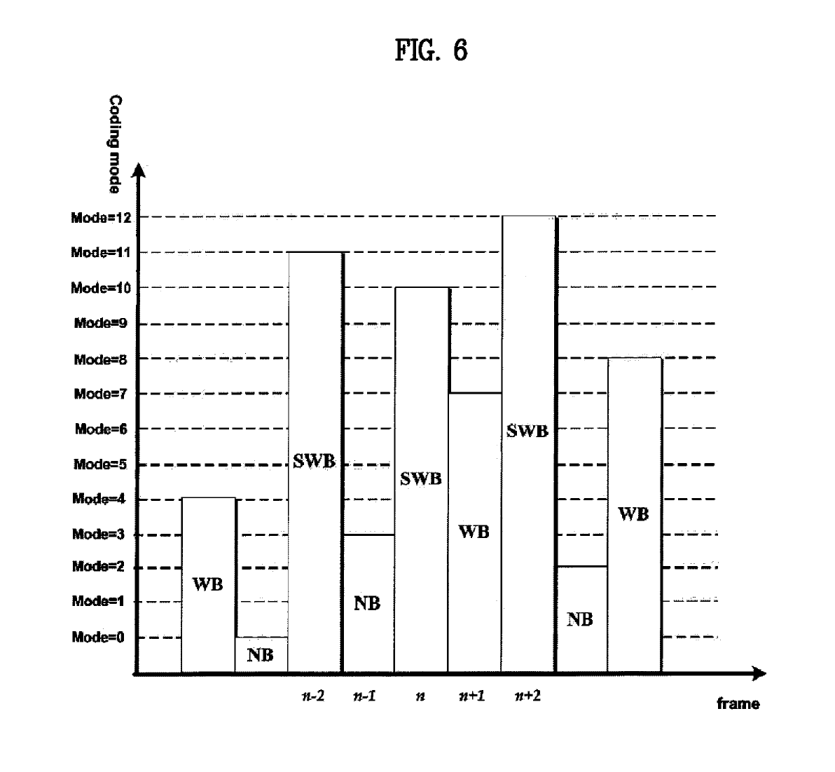

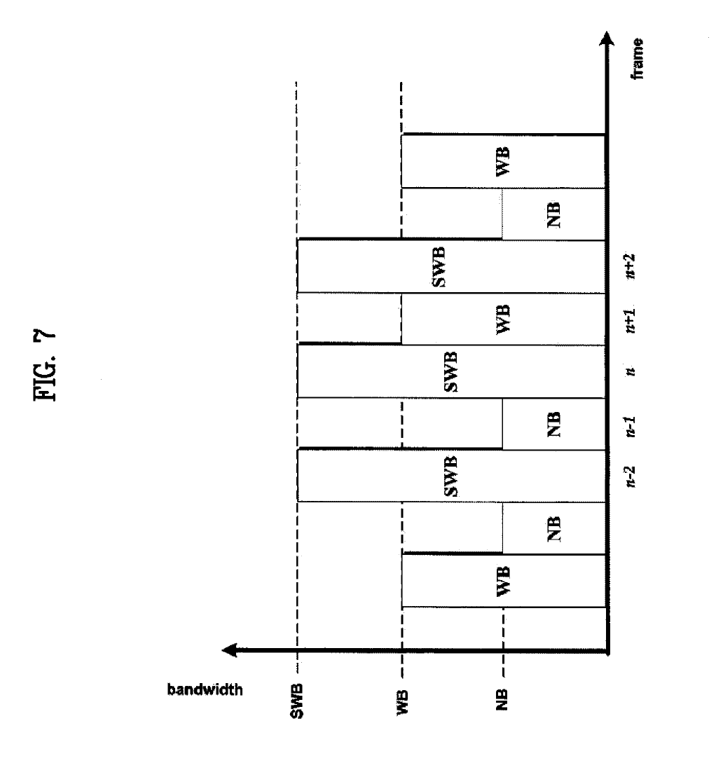

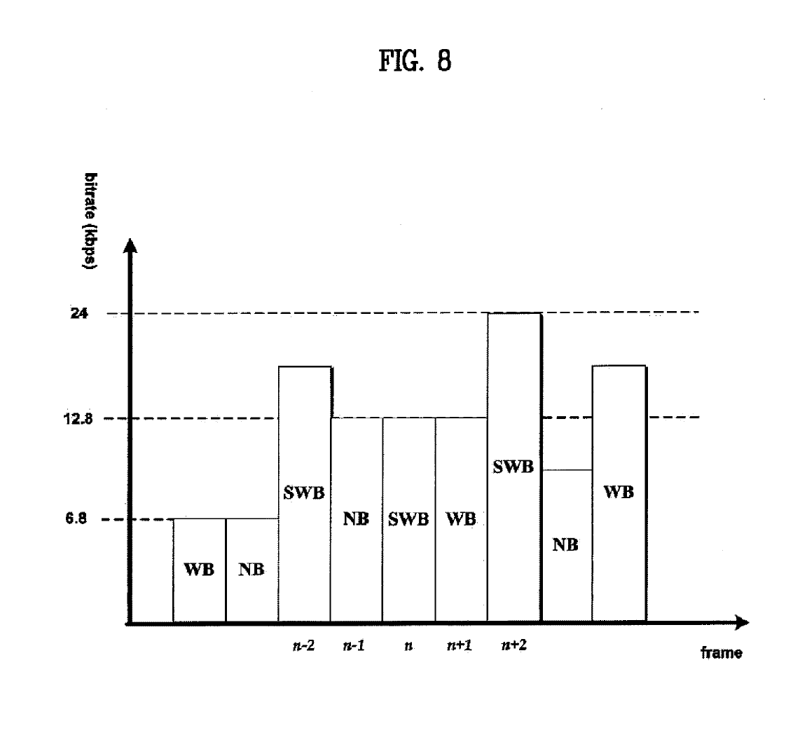

FIG. 6 illustrates an example of coding modes switched for respective frames, FIG. 7 is a graph in which the horizontal axis of the graph in FIG. 6 is represented with bandwidth, and FIG. 8 is a graph in which the horizontal axis of the graph in FIG. 6 is represented with bitrates.

Referring to FIG. 6, the horizontal axis represents frame and the vertical axis represents coding mode. It can be seen that coding modes change as frames change. For example, it can be seen that a coding mode of the (n−1)th frame corresponds to 3 (NB_mode4 in FIG. 5), a coding code of the Nth frame corresponds to 10 (SWB_model in FIG. 5), and a coding code of the (N+1)th frame corresponds to 7 (WB mode4 in the table of FIG. 5). FIG. 7 is a graph in which the horizontal axis of the graph in FIG. 6 is represented with bandwidth (NB, WB, SWB), from which it can also be seen that bandwidths change as frames change. FIG. 8 is a graph in which the horizontal axis of the graph in FIG. 6 is represented with bitrate. As for the (n−1)th frame, the nth frame and the (n+1)th frame, it can be seen that although each of the frames has different bandwidth NB, SWB, WB, all of the frames has a support bitrate of 12.8 kbps.

Thus far, the coding modes have been described with reference to FIGS. 5 to 8. Referring back to FIG. 3, the mode determination unit 110A receives network information indicating a maximum allowable coding mode and determines one or more candidate coding modes based on the received information. For example, in the table illustrated in FIG. 5, in a case that the maximum allowable coding mode is 11 or below, coding modes 0 to 10 are determined as candidate coding modes, among which one is determined as the final coding mode based on characteristics of an audio signal. For example, depending on characteristics of an input audio signal (i.e., depending on at which band information is mainly distributed), in a case that the information is mainly distributed at narrowband (0 to 4 kHz) one of coding modes 0 to 3 may be selected, in a case that the information is mainly distributed at wideband (0 to 8 kHz) one of coding modes 4 to 9 may be selected, and in a case that the information is mainly distributed at super wideband (0 to 16 kHz) coding modes 10 to 12 may be selected.

Referring to FIG. 4, a mode determination unit 110B according to a second example may receive network information and, unlike the first example 110A, determine a coding mode based on the network information alone. Further, the mode determination unit 110B may determine a coding mode of a current frame satisfying requirements of an average transmission bitrate, based on bitrates of previous frames together with the network information. While the network information in the first example indicates a maximum allowable coding mode, the network information in the second example indicates one of a plurality of coding modes. Since the network information directly indicates a coding mode, the coding mode may be determined using this network information alone.

On the other hand, the coding modes described with reference to FIGS. 3 and 4 may be a combination of bitrates of a core layer and bitrates of an enhancement layer, rather than the combination of bandwidth and bitrates as illustrated in FIG. 5. Alternatively, the coding modes may even include a combination of bitrates of a core layer and bitrates of an enhancement layer when the enhancement layer is present in one bandwidth. This is summarized below.

<Switching Between Different Bandwidths>

A. In a case of NB/WB
a) in a case that an enhancement layer is not presented
b) in a case that an enhancement layer is present (mode switching in same band)
b.1) switching an enhancement layer only
b.2) switching a core layer only
b.3) switching both a core layer and an enhancement layer

B. In a case of SWB

split band coding layer by band split

For each of the cases, a bit allocation method depending on a source is applied. If no enhancement layer is present, bit allocation is performed within a core. If an enhancement layer is present, bit allocation is performed for a core layer and an enhancement layer.

As described above, in a case that an enhancement layer is present, bits of bitrates of a core layer may be variably switched for each of frames (in the above cases b.1), b.2) and b.3)). It is obvious that even in this case coding modes are generated based on network information (and characteristics of an audio signal or coding modes of previous frames).

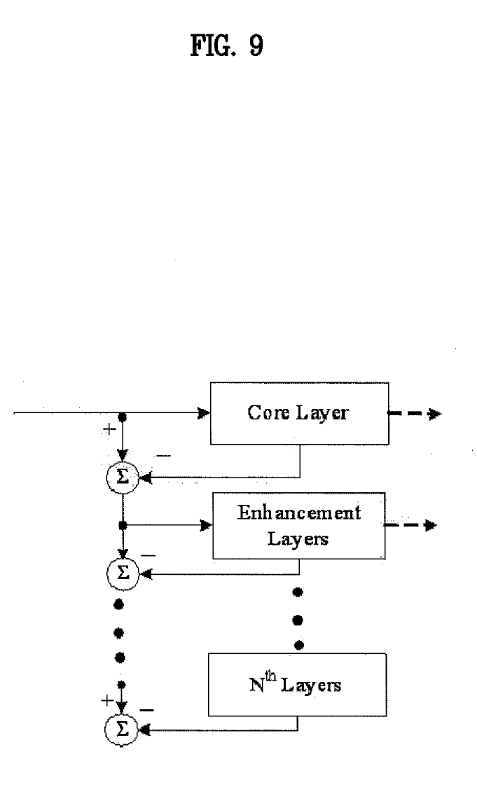

First, the concept of a core layer and enhancement layers will be described with reference to FIG. 9. Referring to FIG. 9, a multi-layer structure is illustrated. An original audio signal is encoded in a core layer. The encoded core layer is synthesized again, and a first residual signal removed from the original signal is encoded in a first enhancement layer. The encoded first residual signal is decoded again, and a second residual signal removed from the first residual signal is encoded in a second enhancement layer. As such, the enhancement layers may be comprised of two or more layers (N layers).

Here, the core layer may be a codec used in existing communication networks or a newly designed codec. It is a structure to complement a music component other than speech signal component and is not limited to a specific coding scheme. Further, although a bit stream structure without the enhancement may be possible, at least a minimum rate of a bit stream of the core should be defined. For this purpose, a block for determining degrees of tonality and activity of a signal component is required. The core layer may correspond to AMR-WB Inter-OPerability (IOP). The above-described structure may be extended to narrowband (NB), wideband (WB), and even super wideband (SWB full band (FB)). In a codec structure of a band split, interchange of bandwidths may be possible.

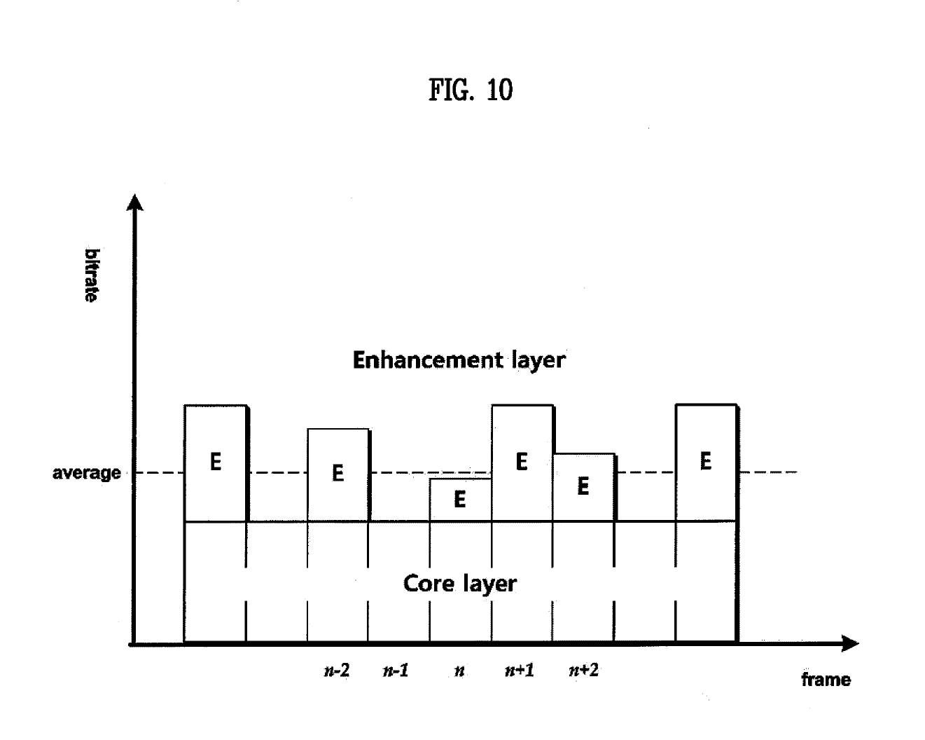

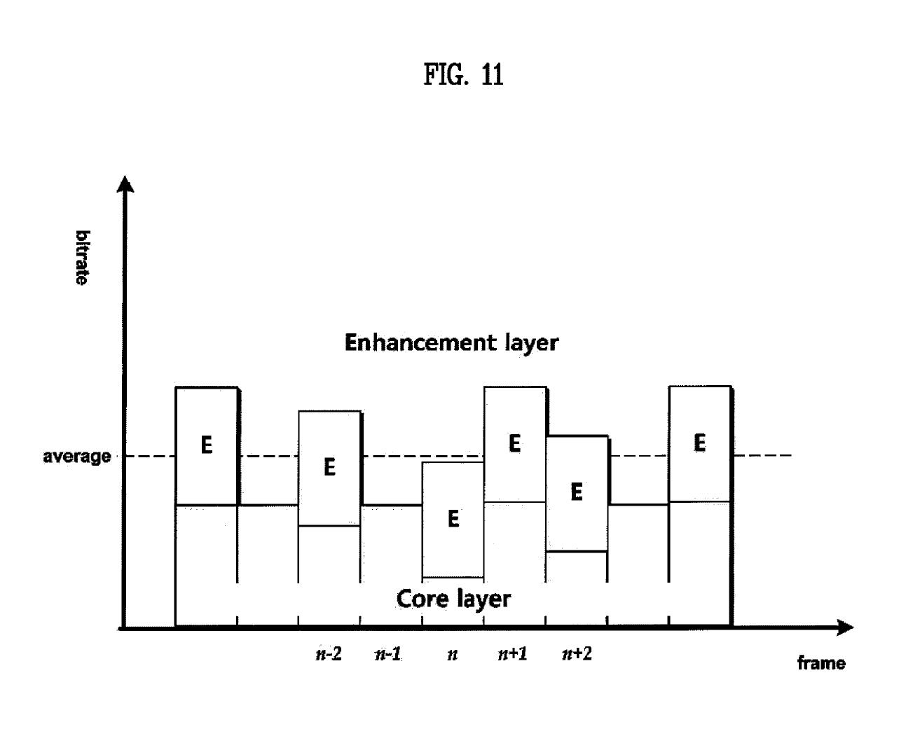

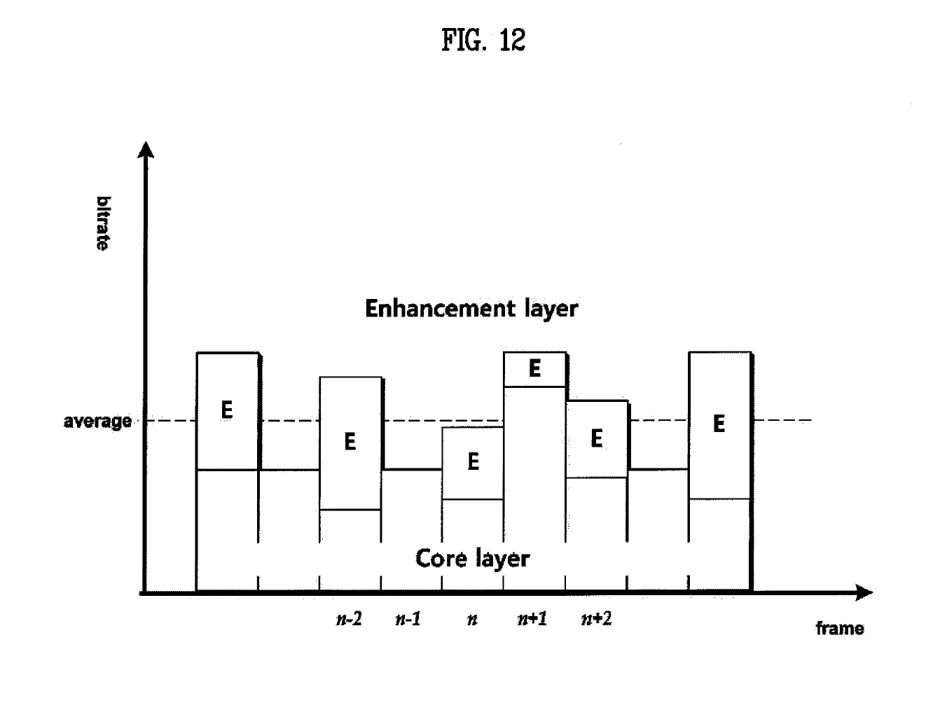

FIG. 10 illustrates a case that bits of an enhancement layer are variable, FIG. 11 illustrates a case that bits of a core layer are variable, and FIG. 12 illustrates a case that bits of the core layer and the enhancement layer are variable.

Referring to FIG. 10, it can be seen that bitrates of a core layer are fixed without being changed for respective frames while bitrates of an enhancement layer are switched for respective frames. On the contrary, in FIG. 11, bitrates of the enhancement are fixed regardless of frames while bitrates of the core layer are switched for respective frames. In FIG. 12, it can be seen that not only bitrates of the core layer but also bitrates of the enhancement layer are variable.

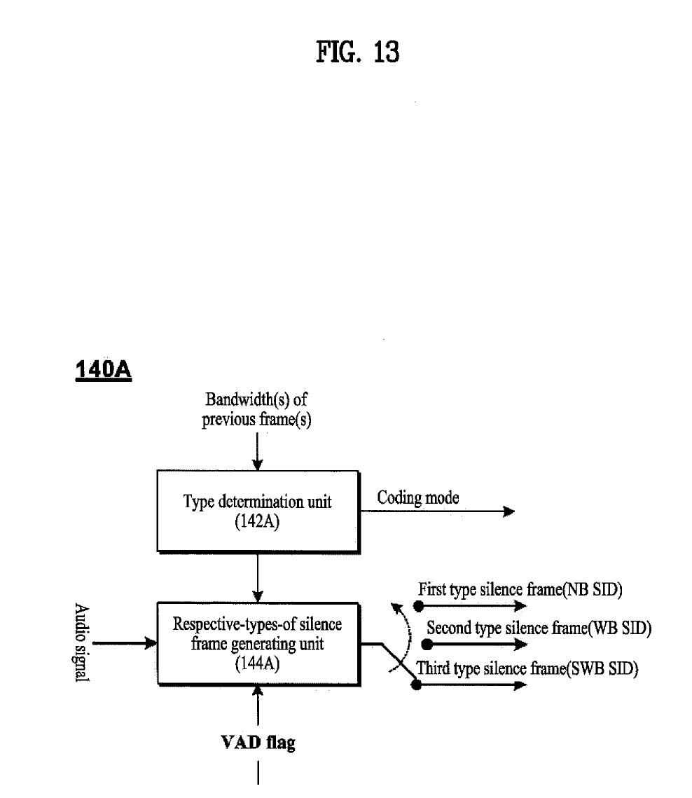

Hereinafter, with reference to FIG. 13 and the like, various embodiments of the silence generating unit 140 of FIG. 1 will be described. Firstly, FIG. 13 and FIG. 14 are diagrams with respect to a silence frame generating unit 140A according to a first example. That is, FIG. 13 is the first example of the silence frame generating unit 140 of FIG. 1, FIG. 14 illustrates a procedure in which a silence frame appears, and FIG. 15 illustrates examples of syntax of respective-types-of silence frames.

Referring to FIG. 13, the silence frame generating unit 140A includes a type determination unit 142A and a respective-types-of silence frame generating unit 144A.

The type determination unit 142A receives bandwidth(s) of previous frame(s), and, based on the received bandwidth(s), determines one type as a type of a silence frame for a current frame, from among a plurality of types including a first type, a second type (and a third type). Here, the bandwidth(s) of the previous frame(s) may be information received from the mode determination unit 110 of FIG. 1. Although the bandwidth information may be received from the mode determination unit 110, the type determination unit 142A may receive the coding mode described above so as to determine a bandwidth. For example, if the coding mode is 0 in the table of FIG. 5, the bandwidth is determined to be narrowband (NB).

FIG. 14 illustrates an example of consecutive frames with speech frames and silence frames, in which an activity flag (VAD flag) is changed from 1 to 0. Referring to FIG. 14, the activity flag is 1 from the first to 35^{th} frames, and the activity flag is 0 from the 36^{th} frame. That is, the frames from the first to the 35^{th} are speech activity sections, and speech inactivity sections begin after the 36^{th} frame. However, in a transition from speech activity sections to speech inactivity sections, one or more frames (7 frames from the 36^{th} to 42th in the drawing) corresponding to the speech inactivity sections are pause frames in which speech frames (S in the drawing), rather than silence frames, are encoded and transmitted even if the activity flag is 0. (The transmission type (TX_type) to be transmitted to a network may be ‘SPEECH_GOOD’ in the sections in which the VAD flag is 1 and in the sections in which the VAD flag is 0 and which are pause frames.)

In a frame after several pause frames have ended, i.e., the 8^{th} frame after the inactivity sections have begun (the 43^{th} frame in the drawing), a silence frame is not generated. In this case, the transmission type may be ‘SID_FIRST’. In the 3^{rd} frame from this (0^{th} frame (current frame(n)) in the drawing), a silence frame is generated. In this case, the transmission type is ‘SID_UPDATE’. After that, the transmission type is ‘SID_UPDATE’ and a silence frame is generated for every 8^{th} frame.

In generating a silence frame for the current frame(n), the type determination unit 142A of FIG. 13 determines a type of the silence frame based on bandwidths of previous frames. Here, the previous frames refer to one or more of pause frames (i.e., one or more of the 36^{th} frame to the 42th frame) in FIG. 14. The determination may be based only on the bandwidth of the last pause frame or all of the pause frames. In the latter case, the determination may be based on the largest bandwidth; however, the present invention is not limited thereto.

FIG. 15 illustrates examples of syntax of respective-types-of silence frames. Referring to FIG. 15, examples of syntax of a first type silence frame (or narrowband type silence frame), a second type silence frame (or wideband type silence frame), and a third type silence frame (or super wideband type frame) are illustrated. The first type includes a linear predictive conversion coefficient of the first order (O₁), which may be allocated the first bits (N₁). The second type includes a linear predictive conversion coefficient of the second order (O₂), which may be allocated the second bits (N₂). The third type includes a linear predictive conversion coefficient of the third order (O₃), which may be allocated the third bits (N₃). Here, the linear predictive conversion coefficient may be, as a result of linear prediction coding (LPC) in the audio encoding unit 130 of FIG. 1, one of line spectral pairs (LSP), Immittance Spectral Pairs (ISP), or Line Spectrum Frequency (LSF) or Immittance Spectral Frequency (ISF). However, the present invention is not limited thereto.

Meanwhile, the first to third orders and the first to third bits have the relation shown below:

The first order (O₁)≦the second order (O₂)≦the third order (O₃)

The first bits (N₁)≦the second bits (N₂)≦the third bits (N₃)

This is because it is preferred that the wider a bandwidth is, the higher the order of a linear predictive coefficient is, and that the higher the order of a linear predictive coefficient is, the larger bits are.

The first type silence frame (NB SID) may further include a reference vector which is a reference value of a linear predictive coefficient, and the second and third type silence frames (NB SID, WB SID) may further include a dithering flag. Further, each of the silence frames may further include frame energy. Here, the dithering flag, which is information indicating periodic characteristics of background noises, may have values of 0 and 1. For example, using a linear predictive coefficient, if a sum of spectral distances is small, the dithering flag may be set to 0; if the sum is large, the dithering flag may be set to 1. Small distance indicates that spectrum envelope information among previous frames is relatively similar. Further, each of the silence frames may further include frame energy.

Although bits of the elements of respective types are different, the total bits may be the same. In FIG. 15, the total bits of NB SID (35=3+26+6 bits), WB SID (35=28+6+1 bits) and SWB_SID (35=30+4+1 bits)) are the same as 35 bits.

Referring back to FIG. 14, in determining a type of a silence frame of a current frame(n) described above, the determination is made based on bandwidth(s) of previous frame(s) (one or more pause frames), without referring to network information of the current frame. For example, in a case that the bandwidth of the last pause frame is referred to, in FIG. 5 if the mode of the 42th frame is 0 (NB_Model), then the bandwidth of the 42th frame is NB, and therefore the type of the silence frame for the current frame is determined to be the first type (NB SID) corresponding to NB. In a case that the largest bandwidth of the pause frames is referred to, if there were four wideband (WB) from 36^{th} to 42th frames, and then the type of the silence frame for the current frame is determined to be the second type (WB_SID) corresponding to wideband. In the respective-types-of silence frame generating unit 144A, a silence frame is obtained using an average value in N previous frames by modifying spectrum envelope information and residual energy information of each of frames for a bandwidth of a current frame. For example, if a bandwidth of a current frame is determined to be NB, spectrum envelope information or residual energy information of a frame having SWB bandwidth or WB bandwidth among previous frames is modified suitably for NB bandwidth, so that a current silence frame is generated using an average value of N frames. The silence frame may be generated for every N frames, instead of every frame. In a section which does not generate silence frame information, spectrum envelope information and residual energy information is stored and used for later silence frame information generation. Referring back to FIG. 13, when the type determination unit 142A determines a type of a silence frame based on bandwidth of previous frame(s) (specifically, pause frames) as stated above, a coding mode corresponding to the silence frame is determined. If the type is determined to be the first type (NB SID), in the example of FIG. 5, then the coding mode may be 18(NB_SID), while if the type is determined to be the third type (SWB SID), then the coding code may be 20(SWB_SID). The coding mode corresponding to the silence frame determined as above is transferred to the network control unit 150 in FIG. 1.

The respective-types-of silence frame generating unit 144A generates one of the first to third type silence frames (NB SID, WB SID, SWB SID) for a current frame of an audio signal, according to the type determined by the type determination unit 142A. Here, an audio frame which is a result of the audio encoding unit 130 in FIG. 1 may be used in place of the audio signal. The respective-types of silence frame generating unit 144A generates the respective-types-of silence frames based on an activity flag (VAD flag) received from the activity section determination unit 120, if the current frame corresponds to a speech inactivity section (VAD flag) and is not a pause frame. In the respective-types-of silence frame generating unit 144A, a silence frame is obtained using an average value in N previous frames by modifying spectrum envelope information and residual energy information of each of frames for a bandwidth of a current frame. For example, if a bandwidth of a current frame is determined to be NB, spectrum envelope information or residual energy information of a frame having SWB bandwidth or WB bandwidth among previous frames is modified suitably for NB bandwidth, so that a current silence frame is generated using an average value of N frames. A silence frame may be generated for every N frames, instead of every frame. In a section which does not generate silence frame information, spectrum envelope information and residual energy information is stored and used for later silence frame information generation. Energy information in a silence frame may be obtained from an average value by modifying frame energy information (residual energy) in N previous frames for a bandwidth of a current frame in the respective-types-of silence frame generating unit 144A.

A control unit 146C uses bandwidth information and audio frame information (spectrum envelope and residual information) of previous frames, and determines a type of a silence frame for a current frame with reference to an activity flag (VAD flag). The respective-types-of silence frame generating unit 144C generates the silence frame for the current frame using audio frame information of n previous frames based on bandwidth information determined in the control unit 146C. At this time, an audio frame with different bandwidth among the n previous frames is calculated such that it is converted into a bandwidth of the current frame, to thereby generate a silence frame of the determined type.

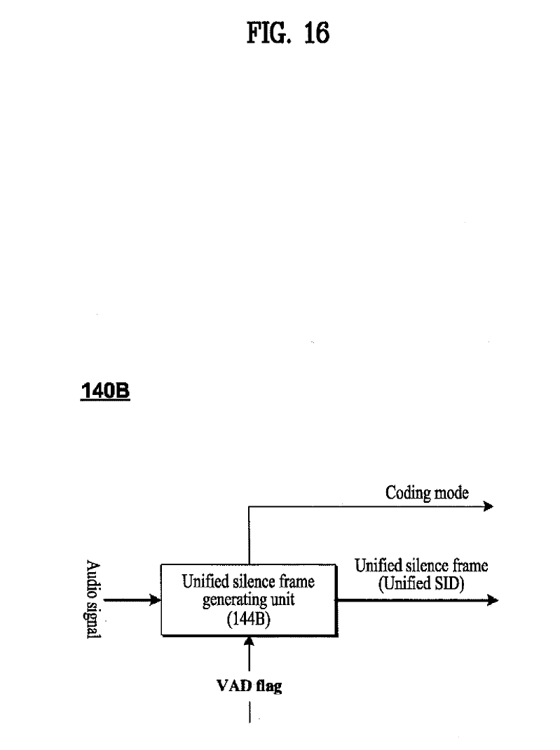

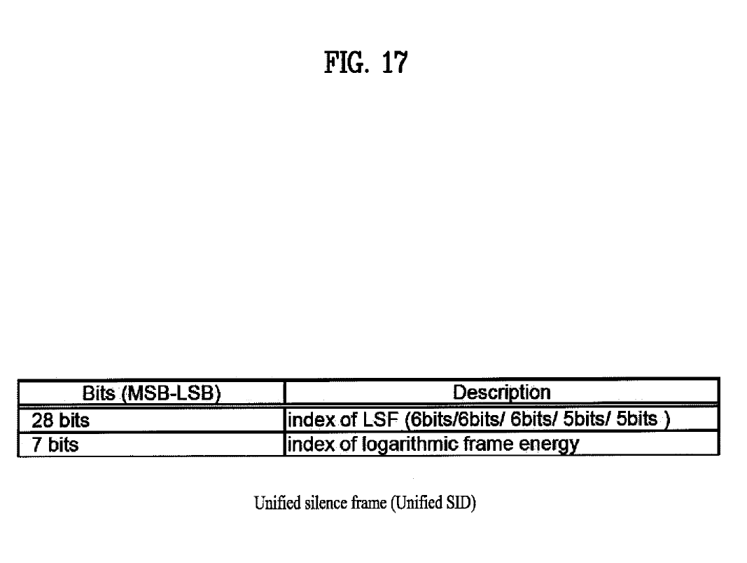

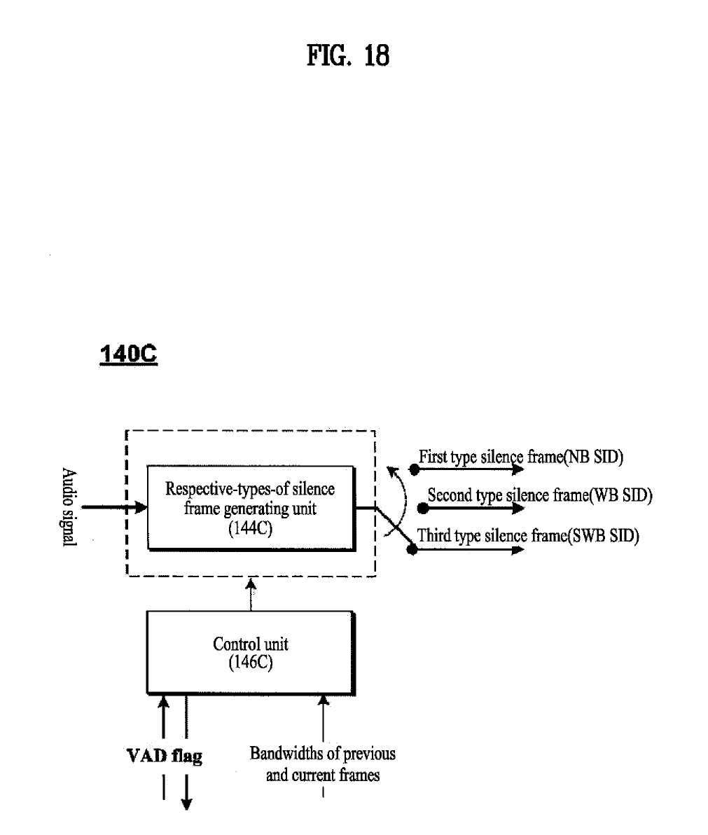

FIG. 16 illustrates a second example of the silence frame generating unit 140 of FIG. 1, and FIG. 17 illustrates an example of syntax of a unified silence frame according to the second example. Referring to FIG. 16, the silence frame generating unit 140B includes a unified silence frame generating unit 144B. The unified silence frame generating unit 144B generates a unified silence frame based on an activity flag (VAD flag), if a current frame corresponds to a speech inactivity section and is not a pause frame. At this time, unlike the first example, the unified silence frame is generated as a single type (unified type) regardless of bandwidth(s) of previous frame(s) (pause frame(s)). In a case that an audio frame which is a result of the audio encoding unit 130 of FIG. 1 is used, results from previous frames are converted into one unified type which is irrelevant to previous bandwidths. For example, if bandwidths information of n previous frames is SWB, WB, WB, NB, . . . SWB, WB (respective bitrates may be different), silence frame information is generated by averaging spectrum envelope information and residual information of n previous frames which have been converted into one predetermined bandwidth for SID. The spectrum envelope information may mean an order of a linear predictive coefficient, and mean that orders of NB, WB, and SWB are converted into certain orders.

An example of syntax of a unified silence frame is illustrated in FIG. 17. A linear predictive conversion coefficient of a predetermined order is included by predetermined bits (i.e., 28 bits). Frame energy may be further included.

By generating a unified silence frame regardless of bandwidths of previous frames, power required for control, resources and the number of modes at the time of transmission may be reduced, and distortions occurring due to bandwidth switching in a speech inactivity section may be prevented.

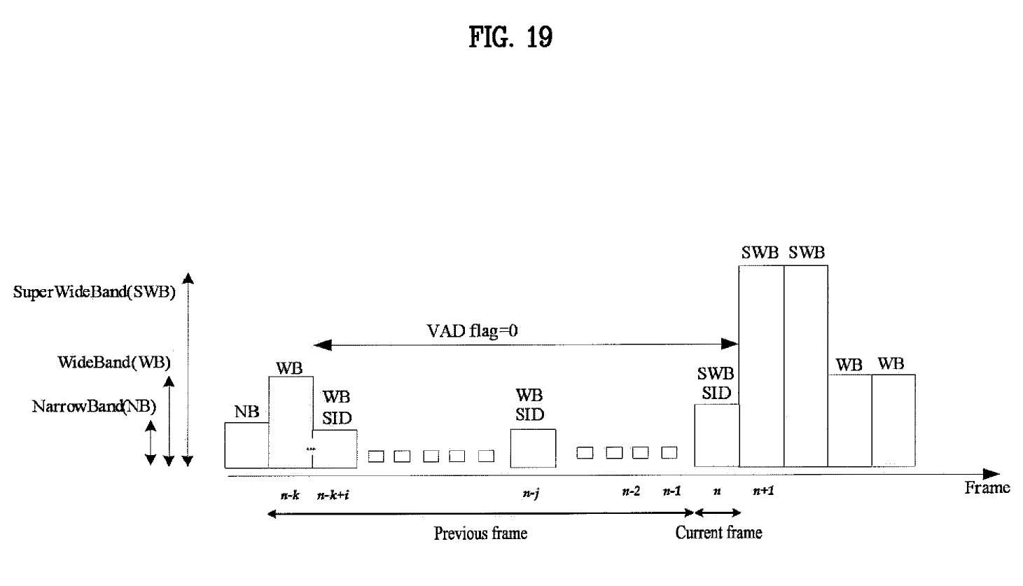

FIG. 18 is a third example of the silence frame generating unit 140 of FIG. 1, and FIG. 19 is a diagram illustrating the silence frame generating unit 140 of the third example. The third example is a variant example of the first example. Referring to FIG. 18, the silence frame generating unit 140C includes a control unit 146C, and may further include a respective-types-of silence frame generating unit 144C.

The control unit 146C determines a type of a silence frame for a current frame based on bandwidths of previous and current frames and an activity flag (VAD flag).

Referring back to FIG. 18, the respective-types-of silence frame generating unit 144C generates and outputs a silence frame of one of first to third type frames according to the type determined by the control unit 146C. The respective-types-of silence frame generating unit 144C is almost same with the element 144A in the first example.

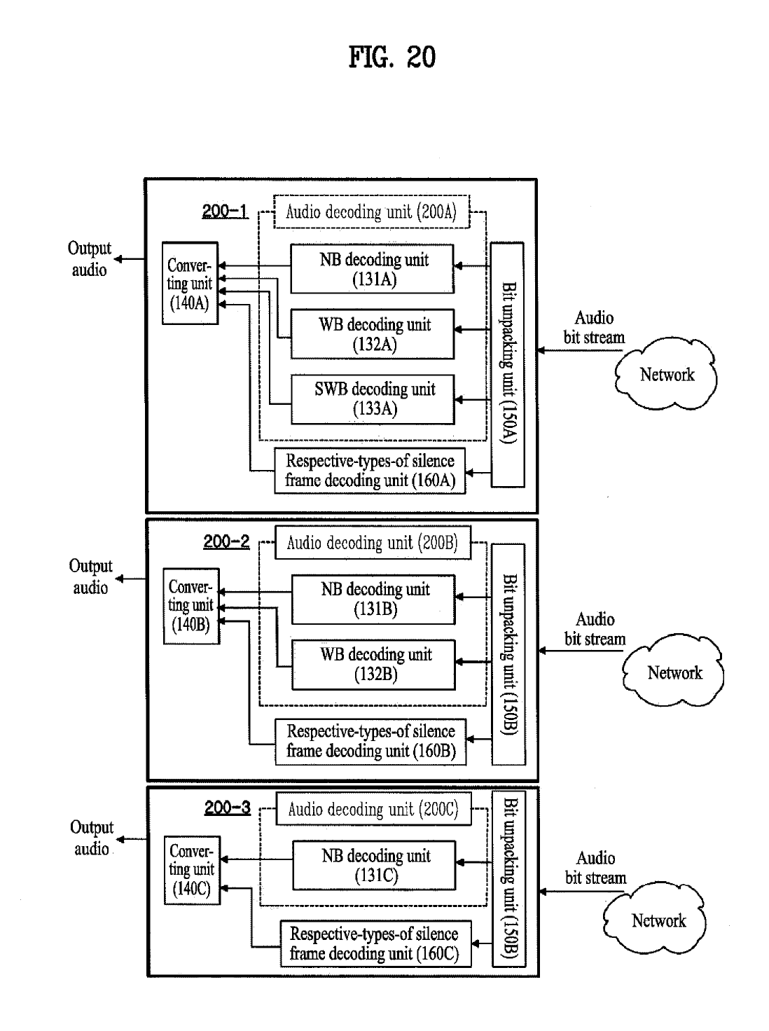

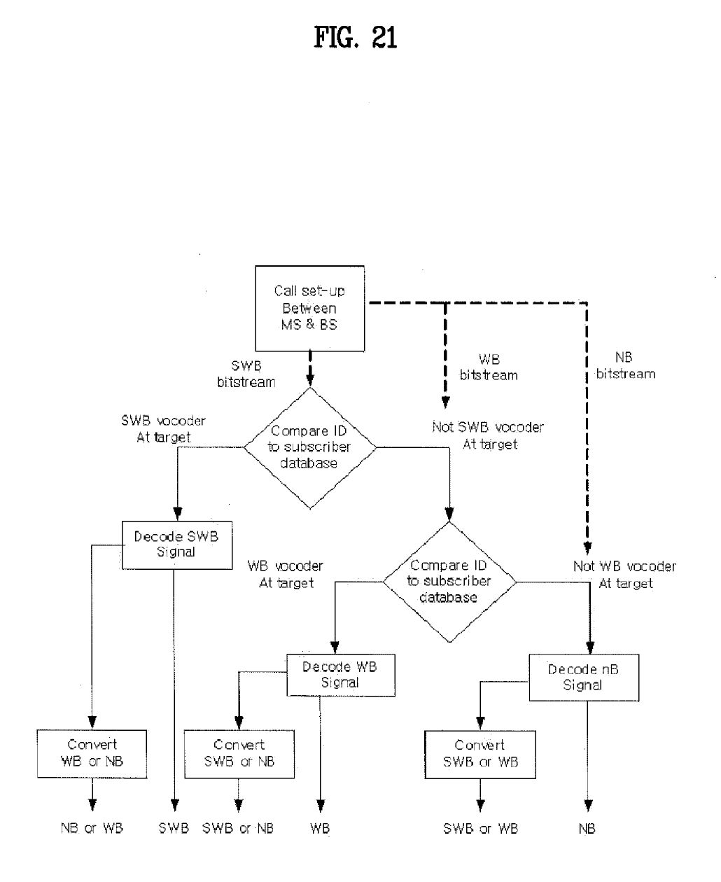

FIG. 20 schematically illustrates configurations of decoders according to the embodiment of the present invention, and FIG. 21 is a flowchart illustrating a decoding procedure according to the embodiment of the present invention.

Referring to FIG. 20, three types of decoders are schematically illustrated. An audio decoding device may include one of the three types of decoders. Respective-types-of silence frame decoding units 160A, 160B and 160C may be replaced with the unified silence frame decoding unit (the decoding block 140B in FIG. 16).

Firstly, a decoder 200-1 of a first type includes all of NB decoding unit 131A, WB decoding unit 132A, SWB decoding unit 133A, a converting unit 140A, and an unpacking unit 150. Here, NB decoding unit decodes NB signal according to NB coding scheme described above, WB decoding unit decodes WB signal according to WB coding scheme, and SWB decoding unit decodes SWB signal according to SWB coding scheme. If all of the decoding units are included, as the case of the first type, decoding may be performed regardless of a bandwidth of a bit stream. The converting unit 140A performs conversion on a bandwidth of an output signal and smoothing at the time of switching bandwidths. In the conversion of a bandwidth of an output signal, the bandwidth of the output signal is changed according to a user's selection or hardware limitation on the output bandwidth. For example, SWB output signal decoded with SWB bit stream may be output with WB or NB signal according to a user's selection or hardware limitation on the output bandwidth. In performing the smoothing at the time of switching bandwidths, after NB frame is output, if a bandwidth of a current frame is an output signal other than NB, the conversion on the bandwidth of the current frame is performed. For example, after NB frame is output, a current frame is SWB signal output with SWB bit stream, bandwidth conversion into WB is performed so as to perform smoothing. WB signal output with WB bit stream, after NB frame is output, is converted into an intermediate bandwidth between NB and WB so as to perform smoothing. That is, in order to minimize a difference between bandwidths of a previous frame and a current frame, conversion into an intermediate bandwidth between previous frames and a current frame is performed.

A decoder 200-2 of a second type includes NB decoding unit 131B and WB decoding unit 132B only, and is not able to decode SWB bit stream. However, in a converting unit 140B, it may be possible to output in SWB according to a user's selection or hardware limitation on the output bandwidth. The converting unit 140B performs, similarly to the converting unit 140A of the first type decoder 200-1, conversion of a bandwidth of an output signal and smoothing at the time of bandwidth switching.

A decoder 200-3 of a third type includes NB decoding unit 131C only, and is able to decode only a NB bit stream. Since there is only one decodable bandwidth (NB), a converting unit 140C is used only for bandwidth conversion. Accordingly, a decoded NB output signal may be bandwidth converted into WB or SWB through the converting unit 140C.

Other aspects of the various types of decoders of FIG. 20 are described below with reference to FIG. 21.

FIG. 21 illustrates a call set-up mechanism between a receiving terminal and a base station. Here, both a single codec and a codec having embedded structure are applicable. For example, an example will be described that a codec has structure in which NB, WB and SWB cores are independent from each other, and that all or a part of bit streams may not be interchanged. If a decodable bandwidth of a receiving terminal and a bandwidth of a signal the receiving unit may output are limited, there may be a number of cases at the beginning of a communication as follows:

| | | | Transmitting terminal | | | | | |
|---|---|---|---|---|---|---|---|---|
| | | | Chip | | | Hardware output | | |
| | | | (supporting decoder) | | | (output bandwidth) | | |
| | | | NB | NB/WB | NB/WB/SWB | NB | NB/WB | NB/WB/SWB |
| Receiving | Chip | NB | ∘ | ∘ | ○ | ∘ | ∘ | ○ |
| terminal | (support- | NB/WB | ∘ | ∘ | ○ | ∘ | ∘ | ○ |
| | ing decod- | NB/WB/ | ∘ | ∘ | ○ | ∘ | ∘ | ○ |
| | er) | SWB | | | | | | |
| | Hardware | NB | ∘ | ∘ | ○ | ∘ | ∘ | ○ |
| | output | NB/WB | ∘ | ∘ | ○ | ∘ | ∘ | ○ |
| | (output | NB/WB/ | ∘ | ∘ | ○ | ∘ | ∘ | ○ |
| | band- | SWB | | | | | | |
| | width) | | | | | | | |

When two or more types of BW bit streams are received from a transmitting side, the received bit streams are decoded according to each routine with reference to types of a decodable BW and output bandwidth at a receiving side, and a signal output from the receiving side is converted into a BW supported by the receiving side. For example, if a transmitting side is capable of encoding with NB/WB/SWB, a receiving side is capable of decoding with NB/WB, and a signal output bandwidth may be up to SWB, referring to FIG. 21, when the transmitting side transmits a bit stream with SWB, the receiving side compare ID of the received bit stream to a subscriber database to see if it is decodable (CompareID). The receiving side requests to transmit WB bit stream since the receiving side is not able to decode SWB. When the transmitting side transmits WB bit stream, the receiving side decodes it and an output signal bandwidth may be converted into NB or SWB, depending on output capability of the receiving side.

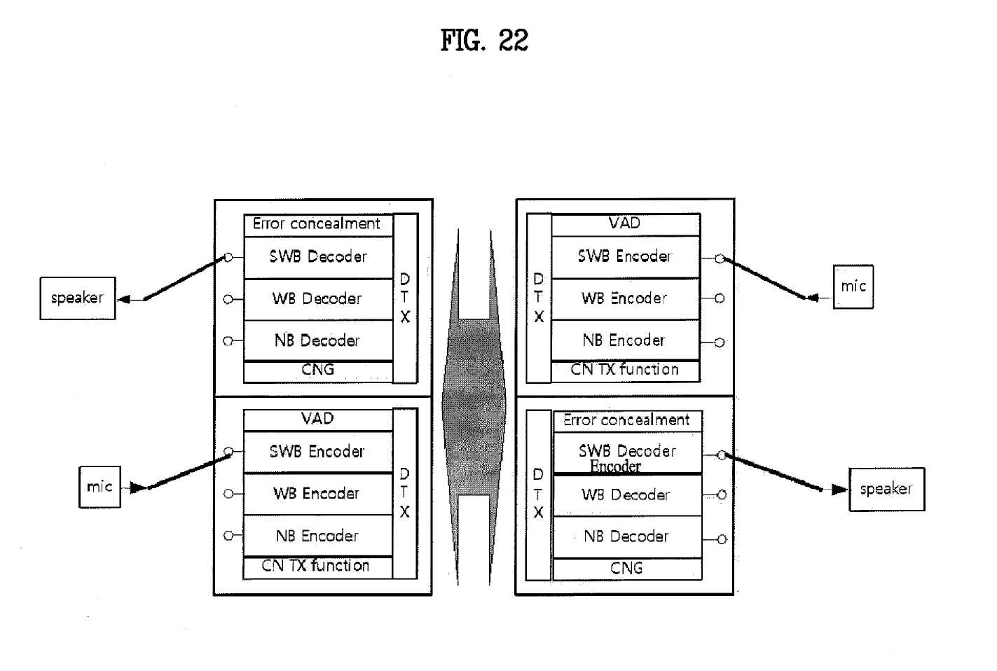

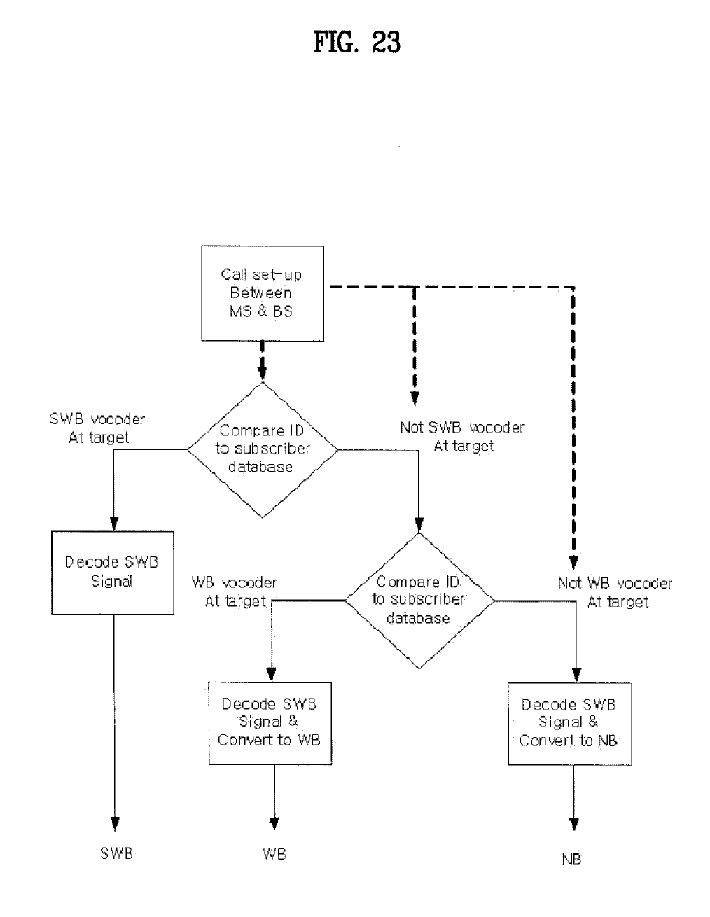

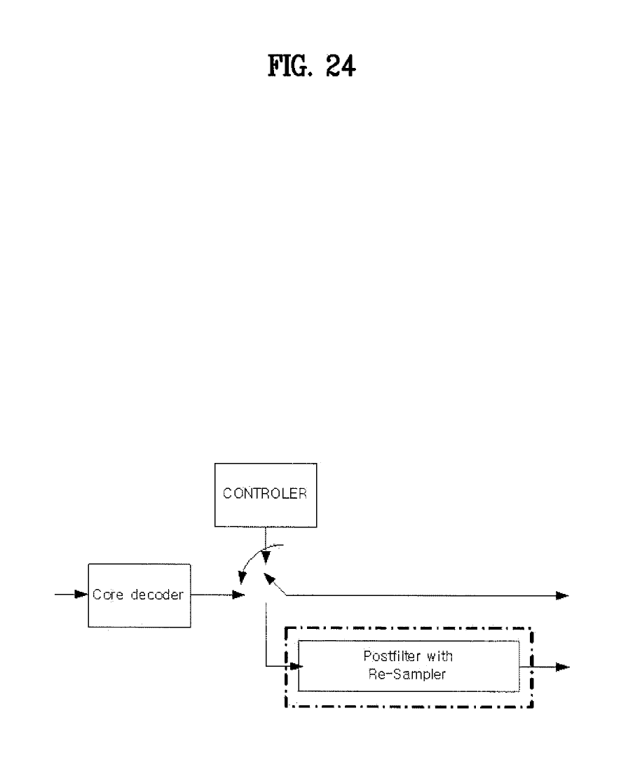

FIG. 22 schematically illustrates configurations of an encoder and a decoder according to an alternative embodiment of the present invention. FIG. 23 illustrates a decoding procedure according to the alternative embodiment, and FIG. 24 illustrates a configuration of a converting unit according to the alternative embodiment of the present invention.

Referring to FIG. 22, all decoders are included in a decoding chip of a terminal such that bit streams of all codecs may be unpacked and decoded in relation to decoding functions. Provided that the decoders have complexity of about ¼ of that of encoders will not be problematic in terms of power consumption. Specifically, if a receiving terminal, which is not able to decode SWB, receives a SWB bit stream, it needs to transmit feedback information to a transmitting side. If transmission bit streams are bit streams of an embedded format, only bit streams in WB or NB out of SWB are unpacked and decoded, and information about decodable BW is transmitted to the transmitting side in order to reduce transmission rate. However, if bit streams are defined as a single codec per BW, retransmission in WB or NB needs to be requested. For this case, a routine needs to be included which is able to unpack and decode all bit streams coming into decoders of a receiving side. To this end, decoders of terminals are required to include decoders of all bands so as to perform conversion into BW provided by receiving terminals. A specific example thereof is as follows:

<<Example of Decreasing Bandwidth>>

A receiving side supports up to SWB—decoded as transmitted.

A receiving side supports up to WB—For a transmitted SWB frame, a decoded SWB signal is converted into WB. The receiving side includes a module capable of decoding SWB.

A receiving side support NB only—For a transmitted WB/SWB frame, a decoded SWB signal is converted into NB. The receiving end includes a module capable of decoding WB/SWB.

Referring to FIG. 24, in a converting unit of the decoder, a core decoder decodes a bit stream. The decoded signal may be output unchanged under control of the control unit or input to a postfilter having a re-sampler and output after bandwidth conversion. If a signal bandwidth that a transmitting terminal is able to output is greater than a output signal bandwidth, the decoded signal is up-sampled to an upper bandwidth, and then the bandwidth is extended, so that a distortion on a boundary of the expanded bandwidth generated upon up-sampling through the postfilter is attenuated. On the contrary, if the signal bandwidth that the transmitting terminal is able to output is smaller than the output signal bandwidth, the decoded signal is down-sampled and its bandwidth is decreased, and may be output through the postfilter which attenuates frequency spectrum on the boundary of the decreased bandwidth.

The audio signal processing device according to the present invention may be incorporated in various products. Such products may be mainly divided into a standalone group and a portable group. The standalone group may include a TV, a monitor, a set top box, etc., and the portable group may include a portable multimedia player (PMP), a mobile phone, a navigation device, etc.

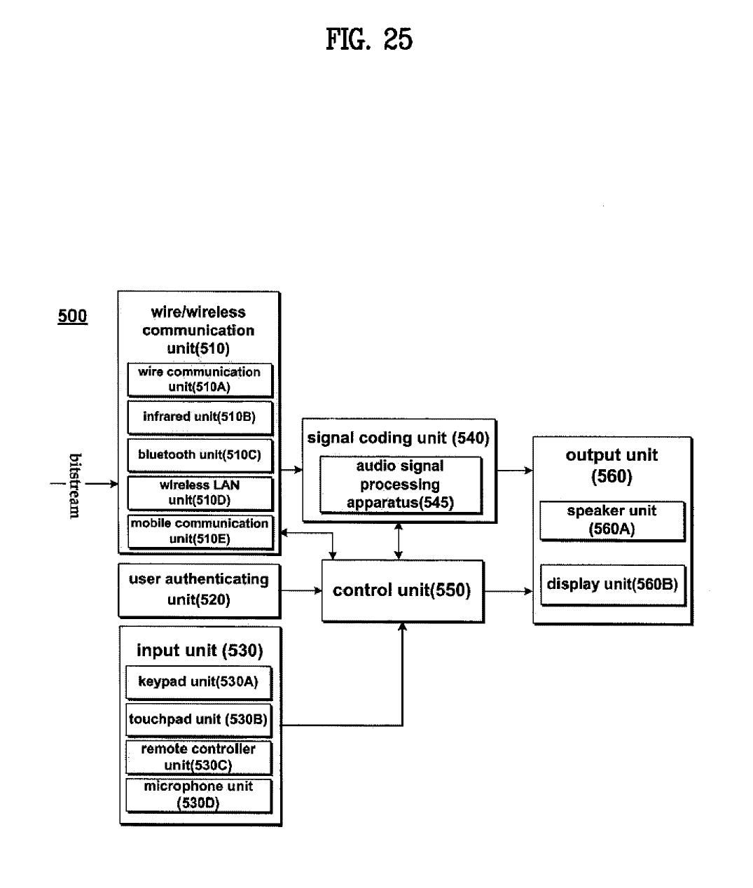

FIG. 25 schematically illustrates a configuration of a product in which an audio signal processing device according to an exemplary embodiment of the present invention is implemented. Referring to FIG. 25, a wired/wireless communication unit 510 receives a bit stream using a wired/wireless communication scheme. Specifically, the wired/wireless communication unit 510 may include at least one of a wire communication unit 510A, an infrared communication unit 510B, a Bluetooth unit 510C, a wireless LAN communication unit 510D, and a mobile communication unit 510E.

A user authenticating unit 520, which receives user information and performs user authentication, may include at least one of a fingerprint recognizing unit, an iris recognizing unit, a face recognizing unit, and a voice recognizing unit. Each of which receives fingerprint, iris, facial contour, and voice information, respectively, converts the received information into user information, and performs user authentication by determining whether the converted user information matches user information or previously registered user data.

A input unit 530, which is an input device for inputting various kinds of instructions from a user, may include at least one of a keypad unit 530A, a touchpad unit 530B, a remote controller unit 530C, and a microphone unit 530D; however, the present invention is not limited thereto. Here, the microphone unit 530D is an input device for receiving a voice or audio signal. Here, the keypad unit 530A, the touchpad unit 530B, and the remote controller unit 530C may receive instructions to initiate a call or to activate the microphone unit 530B. A control unit 550 may, upon receiving an instruction to initiate a call through the keypad unit 530B and the like, cause the mobile communication unit 510E to request a call to a mobile communication network.

A signal coding unit 540 performs encoding or decoding of an audio signal and/or video signal received through the microphone unit 530D or the wired/wireless communication unit 510, and outputs an audio signal in the time domain. The signal coding unit 540 includes an audio signal processing apparatus 545, which corresponds to the above-described embodiments of the present invention (i.e., the encoder 100 and/or decoder 200 according to the embodiments). As such, the audio signal processing apparatus 545 and the signal coding unit including the same may be implemented by one or more processors.

The control unit 550 receives input signals from input devices, and controls all processes of the decoding unit 540 and the output unit 560. The output unit 560, which outputs an output signal generated by the decoding unit 540, may include a speaker unit 560A and display unit 560B. When the output signal is an audio signal, the output signal is output through the speaker, and when the output signal is a video signal, the output signal is output through the display.

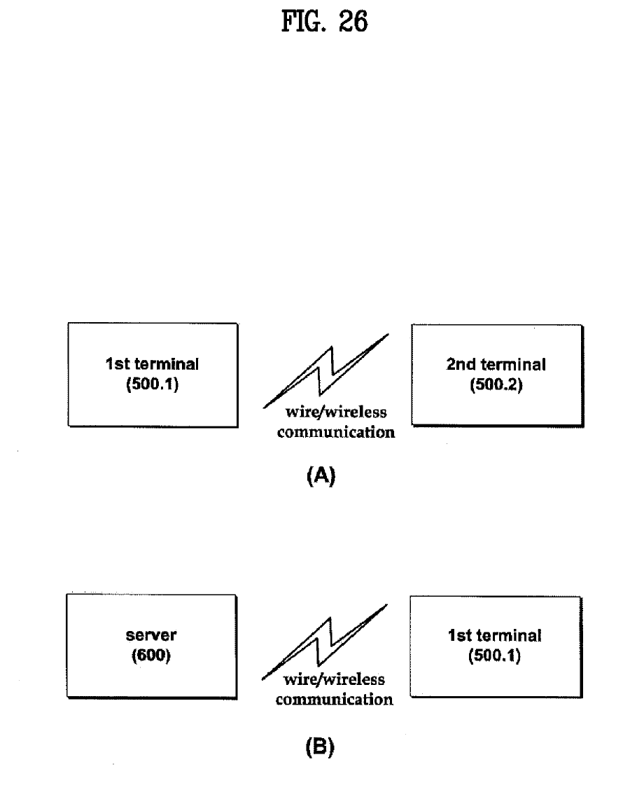

FIG. 26 illustrates a relation between products in which the audio signal processing devices according to the exemplary embodiment of the present invention are implemented. FIG. 26 illustrates a relation between terminals and servers corresponding to the product illustrated in FIG. 25, in which FIG. 26(A) illustrates bi-directional communication of data or a bit stream through a wired/wireless communication unit between a first terminal 500.1 and a second terminal 500.2, while FIG. 26(B) illustrates a server 600 and the first terminal 500.1 also performs wired/wireless communication.

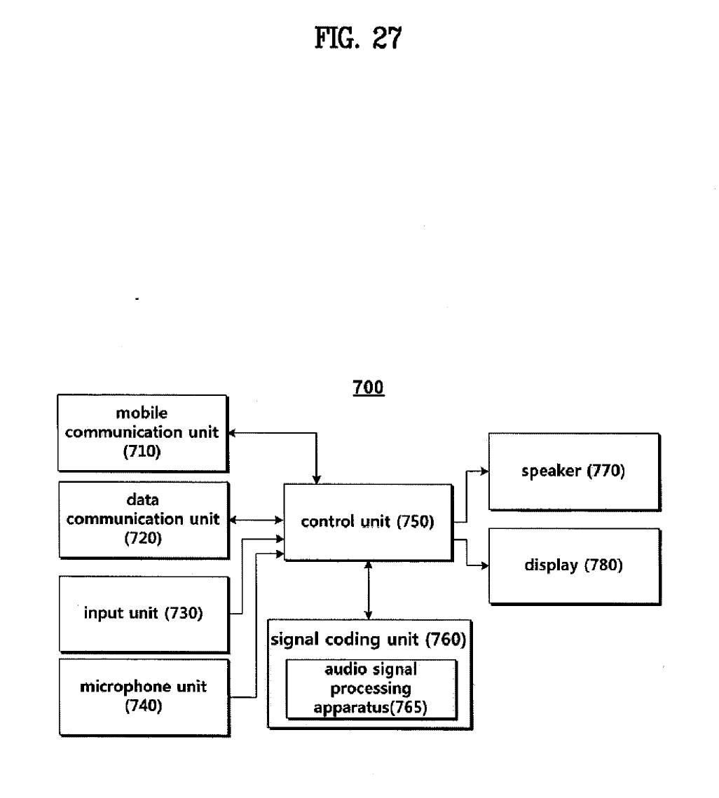

FIG. 27 schematically illustrates a configuration of a mobile terminal in which an audio signal processing device according to the exemplary embodiment of the present invention is implemented. The mobile terminal 700 may include a mobile communication unit 710 for call origination and reception, a data communication unit 720 for data communication, an input unit 730 for inputting instructions for call origination or audio input, a microphone unit 740 for inputting a speech or audio signal, a control unit 750 for controlling elements, a signal coding unit 760, a speaker 770 for outputting a speech or audio signal, and a display 780 for outputting a display.

The signal coding unit 760 performs encoding or decoding of an audio signal and/or a video signal received through the mobile communication unit 710, the data communication unit 720 or the microphone unit 740, and outputs an audio signal in the time-domain through the mobile communication unit 710, the data communication unit 720 or the speaker 770. The signal coding unit 760 includes an audio signal processing apparatus 765, which corresponds to the embodiments of the present invention (i.e., the encoder 100 and/or the decoder 200 according to the embodiment). As such, the audio signal processing apparatus 765 and the signal coding unit 760 including the same may be implemented by one or more processors.

The audio signal processing method according to the present invention may be implemented as a program executed by a computer so as to be stored in a computer readable storage medium. Further, multimedia data having the data structure according to the present invention may be stored in a computer readable storage medium. The computer readable storage medium may include all kinds of storage devices storing data readable by a computer system. Examples of the computer readable storage medium include a ROM, a RAM, a CD-ROM, a magnetic tape, a floppy disk, and an optical data storage device, as well as a carrier wave (transmission over the Internet, for example). In addition, the bit stream generated by the encoding method may be stored in a computer readable storage medium or transmitted through wired/wireless communication networks.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention is applicable to encoding and decoding of an audio signal.

Drawings

| | |
|---|---|
| FIG. 1 | |
| 110: MODE DETERMINATION UNIT | |
| NETWORK INFORMATION | CODING MODE |
| 130: AUDIO ENCODING UNIT | |
| 131: NB ENCODING UNIT | 132: WB ENCODING UNIT |
| 133: SWB ENCODING UNIT | 150: NETWORK CONTROL |
| | UNIT |
| AUDIO SIGNAL | AUDIO FRAME |
| ACTIVITY FLAG | CODING MODE |
| CHANNEL CONDITION INFOR- | NETWORK |
| MATION | |
| AUDIO FRAME OR SILENCE | |
| FRAME | |

120: ACTIVITY SECTION DETERMINATION UNIT
140: SILENCE FRAME GENERATING UNIT 140

| | |
|---|---|
| ACTIVITY FLAG | SILENCE FRAME |
| FIG. 3 | |
| AUDIO SIGNAL | 110A: MODE DETERMINA- |
| | TION UNIT |
| CODING MODE | NETWORK INFORMATION |
| FIG. 4 | |

110B: MODE DETERMINATION UNIT

| | |
|---|---|
| CODING MODE | NETWORK INFORMATION |
| FIG. 5 | |
| BANDWIDTHS | BITRATES |
| 20 ms FRAME BITS | CODING MODES |
| FIG. 13 | |

BANDWIDTH(s) OF PREVIOUS FRAME(S)

| | |
|---|---|
| 142A: TYPE DETERMINATION UNIT | CODING MODE |
| AUDIO SIGNAL | |

144A: RESPECTIVE-TYPES-OF SILENCE FRAME GENERATING
UNIT

| | |
|---|---|
| FIRST TYPE SILENCE FRAME | |
| SECOND TYPE SILENCE FRAME | |
| THIRD TYPE SILENCE FRAME | |
| FIG. 14 | |
| CURRENT FRAME | |
| FIG. 15 | |
| FIRST BITS (N₁) | 10TH ORDER (FIRST |
| | ORDER(O₁)) |
| SECOND BITS (N₂) | 12TH ORDER (SECOND |
| | ORDER(O₂)) |
| THIRD BITS (N₃) | 16TH ORDER (THIRD |
| | ORDER(O₃)) |
| FIG. 16 | |
| CODING MODE | |
| AUDIO SIGNAL | |

144B: UNIFIED SILENCE FRAME GENERATING UNIT

UNIFIED SILENCE FRAME
FIG. 17
UNIFIED SILENCE FRAME
FIG. 18
AUDIO SIGNAL

144C: RESPECTIVE-TYPES-OF SILENCE FRAME GENERATING
UNIT

FIRST TYPE SILENCE FRAME
SECOND TYPE SILENCE FRAME
THIRD TYPE SILENCE FRAME
146C: CONTROL UNIT

BANDWIDTHS OF PREVIOUS AND CURRENT FRAMES

| | |
|---|---|
| FIG. 19 | |
| PREVIOUS FRAME | CURRENT FRAME |
| FIG. 20 | |
| OUTPUT AUDIO | AUDIO BIT STREAM |
| 140A: CONVERTING UNIT | 200A: AUDIO DECODING |
| | UNIT |
| 131A: NB DECODING UNIT | 132A: WB DECODING UNIT |
| 133A: SWB DECODING UNIT | 150A: BIT UNPACKING UNIT |

160A: RESPECTIVE-TYPES-OF SILENCE FRAME DECODING UNIT
NETWORK

| | |
|---|---|
| OUTPUT AUDIO | AUDIO BIT STREAM |
| 140B: CONVERTING UNIT | 200B: AUDIO DECODING |
| | UNIT |
| 131B: NB DECODING UNIT | 132B: WB DECODING UNIT |
| 150B: BIT UNPACKING UNIT | |

160B: RESPECTIVE-TYPES-OF SILENCE FRAME DECODING UNIT
NETWORK

| | |
|---|---|
| OUTPUT AUDIO | AUDIO BIT STREAM |
| 140C: CONVERTING UNIT | 200C: AUDIO DECODING |
| | UNIT |
| 131C: NB DECODING UNIT | 150C: BIT UNPACKINGUNIT |

160C: RESPECTIVE-TYPES-OFSILENCE FRAME DECODING UNIT
NETWORK

1. An audio signal processing method comprising:
receiving an audio signal;
receiving network information indicative of a coding mode;
determining the coding mode corresponding to a current frame;
encoding the current frame of the audio signal according to the coding mode; and,
transmitting the encoded current frame, wherein
the coding mode is determined based on a combination of bandwidths and bitrates, and the bandwidths comprise at least two of narrowband, wideband, and super wideband,
wherein the bitrates comprise two or more predetermined support bitrates for each of the bandwidths.

2. The method according to claim 1, wherein
the super wideband is a band that covers the wideband and the narrowband, and
the wideband is a band that covers the narrowband.

3. The method according to claim 1, further comprising:
determining whether or not the current frame is a speech activity section by analyzing the audio signal,
wherein the determining and the encoding are performed if the current frame is the speech activity section.

4. The method according to claim 1, further comprising:
determining whether the current frame is a speech activity section or a speech inactivity section by analyzing the audio signal;
if the current frame is the speech inactivity section, determining one of a plurality of types including a first type and a second type as a type of a silence frame for the current frame based on bandwidths of one or more previous frames; and
for the current frame, generating and transmitting the silence frame of the determined type, wherein
the first type includes a linear predictive conversion coefficient of a first order,
the second type includes a linear predictive conversion coefficient of a second order, and
the first order is smaller than the second order.

5. The method according to claim 4, wherein
the plurality of types further includes a third type,
the third type includes a linear predictive conversion coefficient of a third order, and
the third order is greater than the second order.

6. The method according to claim 4, wherein
the linear predictive conversion coefficient of the first order is encoded with first bits,
the linear predictive conversion coefficient of the second order is encoded with second bits, and
the first bits are smaller than the second bits.

7. The method according to claim 6, wherein the total bits of each of the first, second, and third types are equal.

8. The method according to claim 1, wherein the network information indicates a maximum allowable coding mode.

9. The method according to claim 8, wherein the determining a coding mode comprises:
determining one or more candidate coding modes based on the network information; and
determining one of the candidate coding modes as the coding mode based on characteristics of the audio signal.

10. The method according to claim 1, further comprising:
determining whether the current frame is a speech activity section or a speech inactivity section by analyzing the audio signal;
if a previous frame is a speech inactivity section and the current frame is the speech activity section, and if a bandwidth of the current frame is different from a bandwidth of a silence frame of the previous frame, determining a type corresponding to the bandwidth of the current frame from among a plurality of types; and
generating and transmitting a silence frame of the determined type, wherein
the plurality of types comprises first and second types,
the bandwidths comprise narrowband and wideband, and
the first type corresponds to the narrowband, and the second type corresponds to the wideband.

11. The method according to claim 1, further comprising:
determining whether the current frame is a speech activity section or a speech inactivity section; and
if the current frame is the speech inactivity section, generating and transmitting a unified silence frame for the current frame, regardless of bandwidths of previous frames,
wherein the unified silence frame comprises a linear predictive conversion coefficient and an average of frame energy.

12. The method according to claim 11, wherein the linear predictive conversion coefficient is allocated 28 bits and the average of frame energy is allocated 7 bits.

13. An audio signal processing device comprising:
a mode determination unit for receiving network information indicative of a coding mode and determining the coding mode corresponding to a current frame; and
an audio encoding unit for receiving an audio signal, for encoding the current frame of the audio signal according to the coding mode, and for transmitting the encoded current frame, wherein
the coding mode is determined based on a combination of bandwidths and bitrates, and
the bandwidths comprise at least two of narrowband, wideband, and super wideband,
wherein the bitrates comprise two or more predetermined support bitrates for each of the bandwidths.

14. The audio signal processing device according to claim 13, wherein the
network information indicates a maximum allowable coding mode.

15. The audio signal processing device according to claim 13, further comprising:
an activity section determination unit for receiving determining whether the current frame is a speech activity section or a speech inactivity section by analyzing the audio signal;
a type determination unit, if the current frame is not the speech inactivity section, for determining one of a plurality of types including a first type and a second type as a type of a silence frame for the current frame based on bandwidths of one or more previous frames; and
a respective-types-of silence frame generating unit, for the current frame, for generating and transmitting the silence frame of the determined type, wherein
the first type includes a linear predictive conversion coefficient of a first order,
the second type includes a linear predictive conversion coefficient of a second order, and
the first order is smaller than the second order.

16. The audio signal processing device according to claim 13, further comprising:
an activity section determination unit for determining whether the current frame is a speech activity section or a speech inactivity section by analyzing the audio signal;
a control unit, if a previous frame is a speech inactivity section and the current frame is the speech activity section, and if a bandwidth of the current frame is different from a bandwidth of a silence frame of the previous frame, for determining a type corresponding to the bandwidth of the current frame from among a plurality of types; and
a respective-types-of silence frame generating unit for generating and transmitting a silence frame of the determined type, wherein
the plurality of types comprises first and second types,
the bandwidths comprise narrowband and wideband, and
the first type corresponds to the narrowband, and the second type corresponds to the wideband.

17. The audio signal processing device according to claim 13, further comprising:
an activity section determination unit for determining whether the current frame is a speech activity section or a speech inactivity section by analyzing the audio signal; and
a unified silence frame generating unit, if the current frame is the speech inactivity section, for generating and transmitting a unified silence frame for the current frame, regardless of bandwidths of previous frames,
wherein the unified silence frame comprises a linear predictive conversion coefficient and an average of frame energy.
